(19) United States
(12) Patent Application Publication
(10) Pub. No.: US 2020/0272669 A1
(43) Pub. Date: Aug. 27, 2020

(54) PREVIEWING ENHANCED SITE SEARCH FUNCTIONALITY FOR WEBSITE

(71) Applicant: Cludo, Inc., Minneapolis, MN (US)

(72) Inventors: Niels Ebbe Ebbesen, Holte (DK); Joshua Bruflodt, Copenhagen (DK)

(21) Appl. No.: 16/284,793

(22) Filed: Feb. 25, 2019

(51) Int. Cl. G06F 16/955; G06F 16/9538; G06F 17/21; G06F 16/957

(52) U.S. Cl. CPC G06F 16/955; G06F 16/957; G06F 17/212; G06F 16/9538

(57) ABSTRACT

In one implementation, a method for providing a preview of a site search for a website includes receiving a URL for a target website to which a site search is to be incorporated and transmitting a configuration preview request to a site search server system. The site search server system accessing the target website in response to the request and generating site search preview code. The method can further include receiving site search preview code from the site search server system and rendering a preview of the site search within a frame of a configuration application. The method can further include receiving a user input of configuring the site search using the configuration application and modifying the display of the preview of the site search in the configuration mode. The method can further include generating configuration data usable to render a modified site search in the target website.

This document generally relates to site search technology, which involves providing search engines to provide search results for search queries run on a particular website. More specifically, this document describes systems and methods for improved site search engines for websites that can provide live previews of site search functionality for websites.

### BACKGROUND

In an increasingly digitizing world, websites are a popular means to convey information to users. A website is generally understood to be a collection of related webpages (e.g., static webpages, dynamic webpages) that are accessible from one or more common domains (e.g., example.com), which may be hosted across one or more web servers. Individuals, as well as companies and organizations, create websites that can be personal and/or professional by nature. Such websites may include corporate websites for internal and/or external user. Such websites may also include blogs, online stores, and other social media outlets. For these websites to serve users in the most effective and efficient way, it is important that the websites have improved and/or optimized searching features integrated in the website. As a result, many website owners prefer implementing internal search engines within their websites to provide “site search” functionality, which is essentially searching that is constrained to a particular website—meaning that the search engine indexes the web site's content and, in response to receiving a site search query, provides the most relevant results to the site search query. This way, instead of going to an external search engine or search website, like GOOGLE or BING, users can more easily search and locate relevant content within the websites by using the internal search engines. Even with the current solutions for providing search engines within websites, search results are often unrelated and/or not properly ranked against other search results that may appear when the user interacts with the search engine. For example, if the website is an online store and the user searches the website for “jeans,” the results may include leggings and cargo pants, both unrelated to the user's desired search query.

### SUMMARY

The present disclosure describes a system and method for provide improved site search functionality for websites, including providing site search previews for websites without a search engine yet being implemented on the websites, and for readily deploying site search functionality on a website directly from a site search preview. For example, as more individuals and companies seek to create websites, they may not have the prerequisite knowledge or skill to develop and deploy advanced search engines within the websites. This can cause websites to be less effective at assisting their users in locating relevant content, and may ultimately undermine the user experience of the website. The disclosed technology provides improved website search engines previewing and deployment so that enhanced site search functionality can be more readily provided on websites, which can improve the user experience by returning more relevant and higher ranked search results when a user interacts with a site search engine. Furthermore, the disclosed technology can more seamlessly and easily integrate creation and customization of the search engine, scraping the web site, and returning more accurate results into one interface, presented to website owners who are able to readily add an improved and/or optimized search engine to their web sites.

Improved site search engines can be provided in a variety of ways. For example, a user interface can be provided through which website owners/managers can, through simply identifying their website, initiate the automated scraping of website content to generate a customized website index. Through this interface and while the index is still being generated, live site search previews can be provided for the website—permitting the user to run search queries and to view actual search results for the website within the website's interface without having installed the site search engine on the website. For instance, a preview search interface can be provided using the web site's interface, with the search interface (e.g., search bar) and search results being provided in the same style as the website and at user designated locations on the website. Such search results can be actual search results for the website, as well—permitting the full user experience of the site search functionality to be previewed without installing or modifying anything on the website. The preview search interface can permit customization and modification of the site search interface for the web site, as well as the underlying site search engine, all again without modifying any of the underlying website. When ready to be deployed, the site search features that a user has designed can be readily ported over to the actual website through a small code snippet (e.g., one line of code) that links to the site search features and customized site search engine hosted on a third party system.

In certain examples, live site search previews can be rendered in different modes, such as a configuration mode and a standalone mode. In the configuration mode, a live site search preview is displayed within a context of a configuration tool that provides an interface for a user to customize the appearance and/or functionality of the site search in the website and that generates configuration data storing the customization of the site search. The configuration data can be used to render the customized site search on the website in runtime, or provide a site search preview in the standalone mode. In the standalone mode, a live site search preview is rendered on a client computing device without the context of the configuration tool and thus appears that the site search is actually running in the web site.

In one implementation, a method for providing a preview of a site search for a website includes receiving, using at least one computing device, a user input of a target website URL for a target website to which a site search is incorporated and transmitting a configuration preview request to a site search server system, the request including the target website URL. The site search server system can access the target website in response to the configuration preview request and generates first site search preview code. The method can further include receiving the first site search preview code from the site search server system and rendering a preview of the site search in a configuration mode using the first site search preview by displaying the preview of the site search within a frame of a configuration application. The method can further include receiving a user input of configuring the site search using the configuration application and modifying the display of the preview of the site search in the configuration mode based on the user input. The method can further include generating configuration data based on the user input, the configuration data usable to render a modified site search in the target website.

The method can optionally include one or more of the following features. The method can further include generating a standalone preview request including a URL hosted by the site search server system, the URL incorporating the configuration data and identifying the target website URL. The configuration data can be in an encoded JSON format. The method can further include transmitting the configuration data to the site search server system, the configuration data stored in the site search server system. The method can further include receiving, using the at least one computing device, a user request for a preview of the site search in a standalone mode and transmitting a standalone preview request to the site search server system, the request including the target website URL and the configuration data. The method can further include receiving second site search preview code from the site search server system and rendering a preview of the modified site search in the standalone mode using the second site preview code and the configuration data by displaying the preview of the modified site search on a browser running on at least one computing device. In the standalone mode, the preview of the site search can be displayed without the frame of the configuration application. The method can further include receiving, using the at least one computing device, a user request for a preview of the site search in a standalone mode and transmitting a standalone preview request to the site search server system, the request including the target website URL. The method can further include receiving second site search preview code and the configuration object from the site search server system and rendering a preview of the modified site search in the standalone mode using the second site preview code and the configuration data by displaying the preview of the modified site search on a browser running on the at least one computing device. The user input of configuring the site search can include at least one of selecting a search result template, selecting a search result sorting type, selecting a language preference, adding a search bar, adding a heading, customizing a style, selecting a search result container, and removing one or more elements from the website.

In another implementation, a site search server system includes a data processing apparatus and a memory device storing instructions that when executed by the data processing apparatus cause the site search server system to perform operations. The operations can include receiving a configuration preview request from the client computing device, the configuration preview request including a target website URL for a target website to which a site search is incorporated and accessing the target website in response to the configuration preview request. The operations can further include generating first site search preview code, transmitting the first site search preview code to the client computing device, the first site search preview code being used by the client computing device to render a configuration preview mode for a site search in the target website by displaying a preview of the site search within a frame of a configuration application, and receiving configuration data from the client computing device, the configuration data including configuration of the site search made using the configuration application.

The site search server system can optionally include one or more of the following features. The instructions can further cause the site search server system to perform operations including scraping the target website from the client web server and indexing the target website. The instructions can further cause the site search server system to perform operations including adding reference to a site search script to the target website, the site search script identifying a site search engine for the target web site, the site search engine hosted by the site search server system. The site search server system can further include a configuration database. The instructions can further cause the site search server system to perform operations including storing the configuration data in the configuration database. The instructions can further cause the site search server system to perform operations including receiving a standalone preview request from the client computing device, the standalone preview request including the target website URL and the configuration data and transmitting second site search preview code to the client computing device, the second site search preview code being used by the client computing device to generate a standalone preview mode for the site search in the target website by displaying a preview of the site search on a browser running on the client computing device, the preview of the site search modified based on the configuration data. The instructions can further cause the site search server system to perform operations including receiving a standalone preview request from the client computing device, the standalone preview request including the target website URL and transmitting second site search preview code and the configuration data to the client computing device, the second site search preview code being used by the client computing device to generate a standalone preview mode for the site search in the target website by displaying a preview of the site search on a browser running on the client computing device, the preview of the site search modified based on the configuration data. In the standalone mode, the preview of the site search can be displayed without the frame of the configuration application. The configuration data include information about at least one of a search result template, a search result sorting type, a language preference, a search bar, a heading, customizing a style, a search result container, and one or more elements removed from the website. The instructions can further cause the site search server system to perform operations including receiving a request for removing a subject element from the target website, the subject element having no identifier, obtaining a Document Object Model (DOM) for the target website, traversing up the DOM from the subject element, identifying a reference element having an identifier in the DOM, building a running trail from the subject element and the reference element, and creating an identifier for the subject element using the running trail.

In another implementation, a non-transitory computer-readable medium having stored therein a program for causing a computer to execute a process of providing a preview of a site search for a web site, the process can include receiving a user input of a target web site URL for a target website to which a site search is incorporated and transmitting a configuration preview request to a site search server system, the request including the target website URL. The site search server system can access the target website in response to the configuration preview request and generates first site search preview code. The process can further include receiving the first site search preview code from the site search server system, rendering a preview of the site search in a configuration mode using the first site search preview by displaying the preview of the site search within a frame of a configuration application, and receiving a user input of configuring the site search using the configuration application. The process can further include modifying the display of the preview of the site search in the configuration mode based on the user input and generating configuration data based on the user input, the configuration data usable to render a modified site search in the target website.

The non-transitory computer-readable medium can optionally include one or more of the following features. The process can further include receiving a user request for a preview of the site search in a standalone mode, transmitting a standalone preview request to the site search server system, the request including the target website URL and the configuration data, receiving second site search preview code from the site search server system, and rendering a preview of the modified site search in the standalone mode using the second site preview code and the configuration data by displaying the preview of the modified site search on a browser running on the at least one computing device. The user input of configuring the site search can include at least one of selecting a search result template, selecting a search result sorting type, selecting a language preference, adding a search bar, adding a heading, customizing a style, selecting a search result container, and removing one or more elements from the website.

The subject matter described in this specification can be implemented in particular implementations, so as to realize one or more of the following advantages. For example, this technology can permit a user to simultaneously customize and change features of search results and the search engine while the website is being indexed and scraped (e.g., crawled) in the background. Wait time for the user can be diminished as the user will not be waiting idly for the indexing and scraping to finish before being able to customize and change features of the search results and the search engine. In another example, the process of indexing and scraping is automated, which can minimize technical hurdles to add enhanced site search functionality to a website. In another example, a default style sheet can be generated as a result of scraping the website of its style sheets, thereby making it easier and quicker to implement the improved search engine in a default style that matches the style of the entire website.

The details of one or more implementations of the subject matter of this specification are set forth in the Detailed Description, the Claims, and the accompanying drawings. Other features, aspects, and advantages of the subject matter will become apparent from the Detailed Description, the Claims, and the accompanying drawings.

### BRIEF DESCRIPTION OF DRAWINGS

FIG. 1A is a block diagram illustrating an example system that generates a live preview in a configuration mode as described in the instant disclosure.

FIG. 1B is a block diagram illustrating an example system that generates a live preview in a standalone mode as described in the instant disclosure.

FIG. 2 is a block diagram illustrating an example network system comprising one or more computing devices and one or more servers configured to communicate with each other over a network.

FIGS. 3A-3K are screenshots illustrating an exemplary site search preview interface.

FIG. 4 is a flowchart illustrating an example method for creating a search tool.

FIG. 5 is a flowchart illustrating an example method for generating a search results preview.

FIGS. 6A-6G are screenshots illustrating exemplary site search preview interfaces in the configuration mode.

FIG. 6H is a screenshot illustrating an exemplary site search preview interface in the standalone mode.

FIG. 7 is an example configuration code.

FIG. 8 is a flowchart of an example method for determining an element identifier.

FIG. 9A is a block diagram illustrating another example system that generates a live preview and search results while simultaneously scraping a website and permitting a user to edit the search results appearance, as described in the instant disclosure.

FIG. 9B is a block diagram illustrating an example system in run-time, when a user device receives the updated search results

Like reference numbers and designations in the various drawings indicate like elements.

### DETAILED DESCRIPTION

The following detailed description describes systems and methods for providing enhanced site search features for websites, including providing site search previews and permitting ready deployment of site search functionality on websites. Such features can be implemented in any of a variety of ways, such as through creating an index of an existing website by scraping the website and, while scraping the website, simultaneously generating improved search results for the website by generating and displaying to a user a live search preview. The live search preview can be generated in different modes, such as a configuration mode and a standalone mode. The live search preview in the configuration mode can permit a user to conduct test searches and customize the search results, and can also be used to generate simple code to implement the improved search engine in the website, such as when it is later requested to be accessed by a user at a client device. The user customization made in the configuration mode can be stored in configuration data that are later used to execute the standalone mode of live site search preview in which the live search preview is displayed as if the site search and search results are actually performed in the website. The configuration data can also be used to run the customized site search on the website in runtime.

In one embodiment, a server comprises many crawlers and search engines. A user at a client device can choose which of one or more websites are be assigned to one or more search engines. The one or more search engines are associated (e.g., linked) to one or more websites by that website's crawler (e.g., index). One search engine may also be matched (e.g., linked or associated) to one or many crawlers. This creates a many-to-many relationship and may be advantageous to users that own large websites with much data and webpages to search. The many-to-many relationship makes it more efficient to create improved search engines for the website because more associations are created. Furthermore, the many-to-many relationship provides for many search queries per website to have many search rankings.

In another embodiment, the user can add more than one URL to scrape one website associated with that URL. In other words, the user may add one or more domains to scrape (e.g., crawl) that are associated with one website. Additionally, many websites can be scraped at once. The user may customize a type of information that the scraping identifies and returns as search results when a search query is conducted. For example, an owner of a law firm website may customize the search engine so that search results include only lawyer names and their associated phone numbers when a user conducts a search query.

In other embodiments, a user may boost a webpage or search results in comparison to other webpages or search results. The user may customize boosting so that only some fields, for example, within a webpage are identified when the website is scraped (e.g., crawled). The search engine may also consider where on the website, and each particular webpage, the most relevant information is. The search engine may identify fields, information, and/or elements based on identifiers associated with those fields, information, and/or elements. These identifiers may be derived from a DOM tree. In other embodiments, the user may also increase or decrease a boosting ranking by inputting a particular value that a particular field and/or element should contain. The embodiments discussed above about boosting may also be applied to webpage ranking. Furthermore, machine learning (ML) may examine what users search for or click on in a website and in each webpage comprising that website. In other embodiments, the machine learning may take into account dwell time by users on each of the webpages comprising the website. In so doing, the machine learning facilitates to return improved and/or optimized search results that encompass the most relevant results ranked from most popular to least popular. In other embodiments, the search results can be customized to return search results ranked based on other characteristics and even user-defined characteristics.

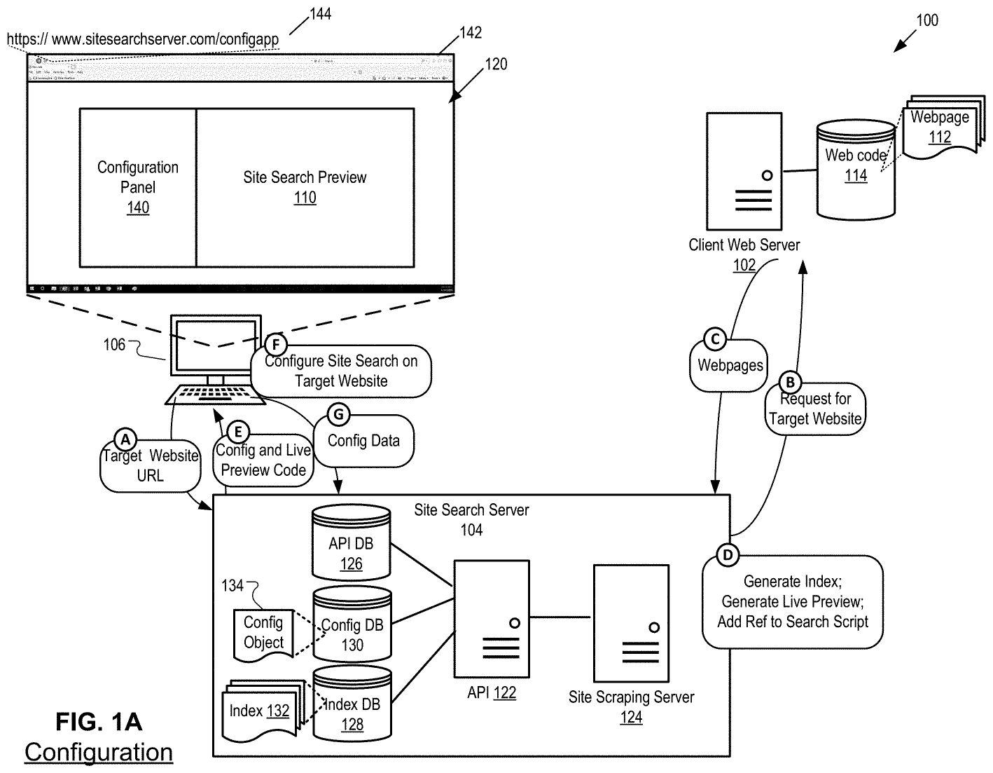

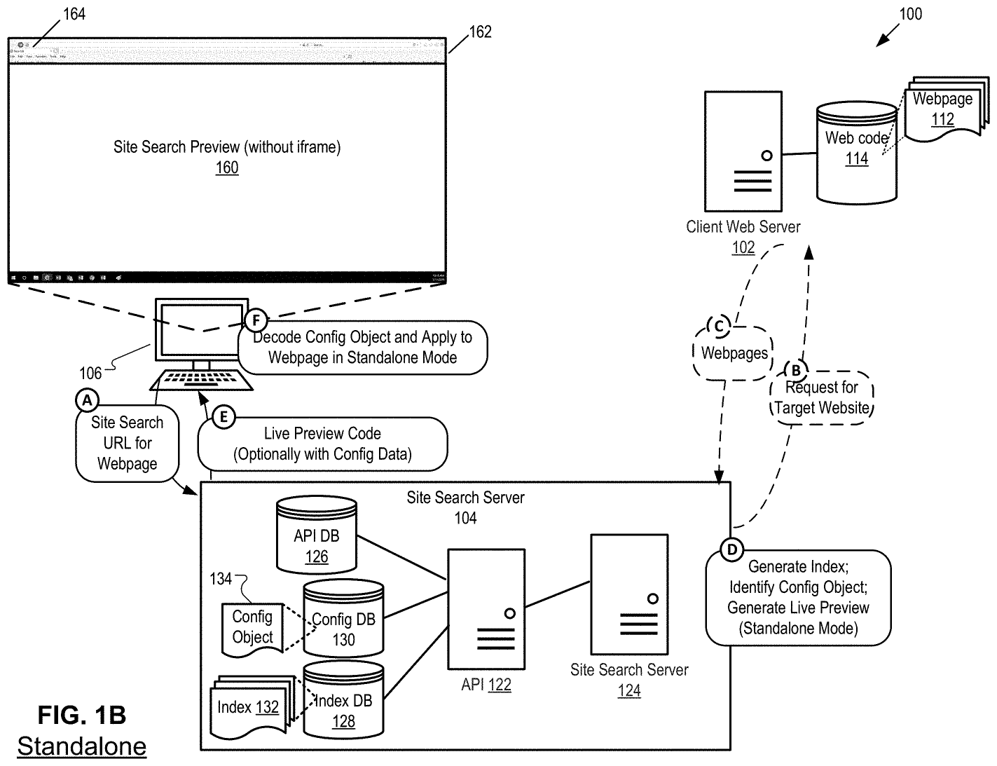

FIG. 1A is a block diagram illustrating an example system 100 that generates a live site search preview in a configuration mode. The system 100 includes a client web server 102, a site search server 104, and a client computing device 106.

In general, the system 100 generates live site search previews 110 with site search results for a target web site while at the same time scraping the target web site and permitting a user to edit the appearance of the search results that is displayed via the live site search preview 110 on the client computing device 106. The system 100 can present live site search previews 110 in multiple different modes, including a configuration mode (e.g., FIG. 1A) and a standalone mode (e.g., FIG. 1B). In configuration mode, the live site search previews 110 are presented with user interface features permitting users to configure the live site search previews 110 on the fly. The live site search previews 110 can be presented, for example, using wrappers (e.g., iframes) through which the content of the live site search previews 110 can be presented along with the configuration features. In standalone mode, the live site search previews 110 can be presented as it would be if the code were implemented on the target website itself (without the configuration user interface features), but still as a preview (not live on the target website).

The client web server 102 hosts one or more webpages 112 of a client website to which a site search is added during a configuration preview mode described herein. The web server 102 connects to a web code database 114 storing code (e.g., HTML, scripts, style sheets, server-side code, client-side code) that the web server 102 executes and/or distributes to provide the webpages 112 on client devices. Together, the webpages 112 can be considered to collectively be a website that is hosted by the web server 102. The site search server 104 interacts with the client web server 102 to make requests (e.g., standard HTTP requests). In some embodiments, such an interaction may be the only interaction between the site search server 104 and the client web server 102.

The site search server 104 provides a configuration application 120 that can run on the client computing device 106 and is configured to generate the live site search preview 110 and permit a user to edit the appearance and/or functionality of a site search on the client web site. The configuration application 120 is a tool for site search customers that allows them to configure the site search products and view relevant analytics. The site search server 104 (e.g., the API server 122) provides a backend web server component that the configuration application 120 interacts with when the configuration application 120 runs on the client computing device 106. In the context of site search previews, the site search server 104 operates to fetch and modify the target client website.

In some embodiments, the site search server 104 is configured to scrape and index one or more webpages 112 of the website. The site search server 104 is further configured to generate a live site search preview 110, generate the code to view the live site search preview 110 on the client computing device106, and generate code (e.g., modify HTML) of the one or more webpages 112 to show the search results. The site search server 104 can also simultaneously scrape one or more webpages 112 of the web site and, at the same time, generate the improved search engine, the live site search preview 110, and the search results for the website.

In some embodiments, the site search server 104 can include an API server 122, a site scrapping server 124, an API database 126, and an index database 128. In addition, the site search server 104 can include a configuration database 130.

The API server 122 communicates with the web server 102 and the client computing device 106 via one or more networks. The API server 122 can connect to the API database 126 configured to store APIs and code (e.g., JavaScript code) hosted by the site search server 104. The API server 122 can further connect to the index database 128 that includes indices 132 for websites that are used by the site search server 104 to process site search queries for the websites. The API server 122 can generate the indices 132 for a target website and its webpages 112. In some embodiments, the index database 128 can additionally store content from the websites that are indexed, such as HTML code, style sheets, scripts, DOM tree for the interpreted website, and/or others. The indices 132 organize the content of the websites so that they can be readily searched to identify relevant content to provide in search results for site search queries. The API server 122 can provide site search services for the websites that are indexed, such as by receiving site search queries from web servers hosting the indexed websites and/or from client devices interpreting the website code, processing the site search queries using the indices, and returning the site search results. The site search results can include, for example, particular webpages from a website (and/or other portions of websites) that are relevant to a site search query for the website.

The API server 122 can further connect to the configuration database 130 that stores configuration objects 134. Configuration objects 134 contain configuration data that can be used to configure the appearance and/or functionality of site search features in websites, and can be used to designate the insertion of site search features into a website (without modifying the underlying website code, except for adding code to load the configuration data and other code to dynamically insert the site search features on client devices). Configuration data can be generated while users modify live site search previews using configuration applications 120, and can be used for both live previews of websites and in production (live on websites).

The site scraping server 124 can communicate with the client web server 102 and scrape website content, which can be used to present the live preview and to build an index that is used to preview live search results in the preview. For example, the site scraping server 124 can scrape content from the webpages 112 by requesting the webpages 112 as well as all of the files/resources that the webpages 112 include/incorporate (e.g., scripts, style sheets). Example methods for scraping websites are described in more details herein.

The client computing device 106 communicates with the site search server 104 and/or the web server 102 to use and configure the live preview. The client computing device 106 can be used by a website owner, manager, or other person or entity who control the website or what is presented on the website. The client computing device 106 can be used to initiate, review, and approve site search previews as described herein in further detail.

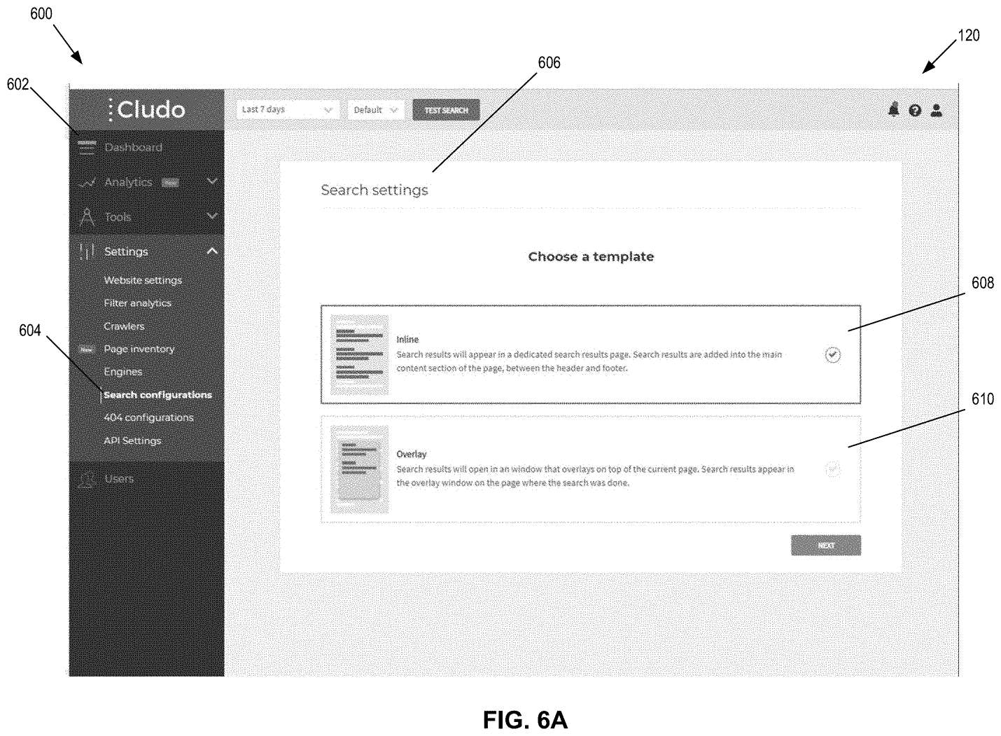

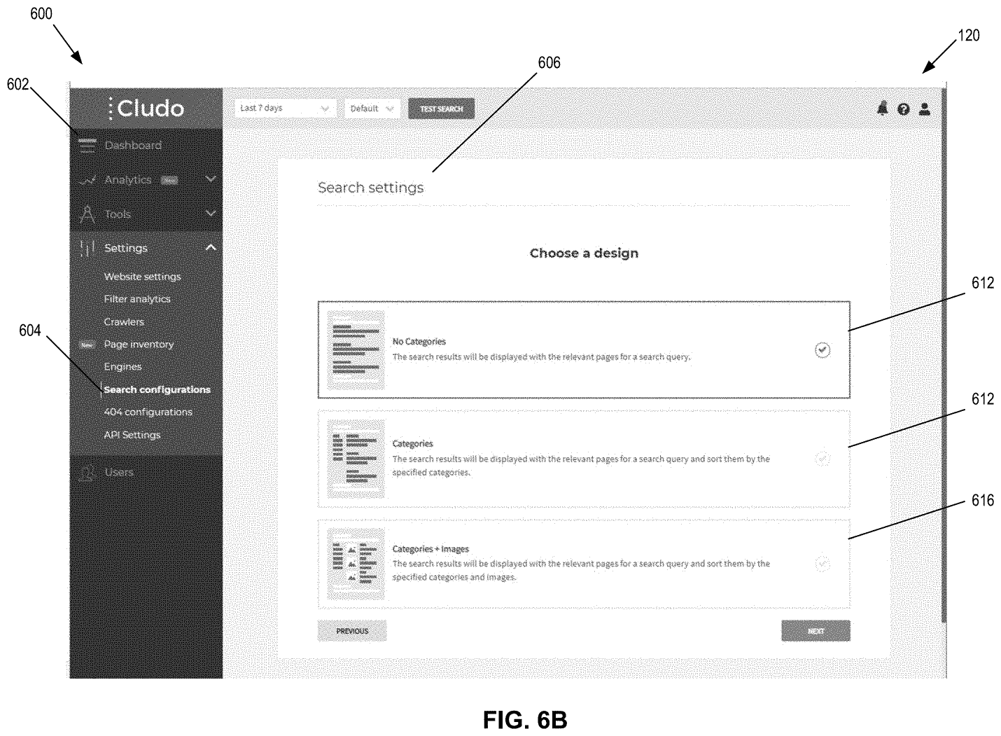

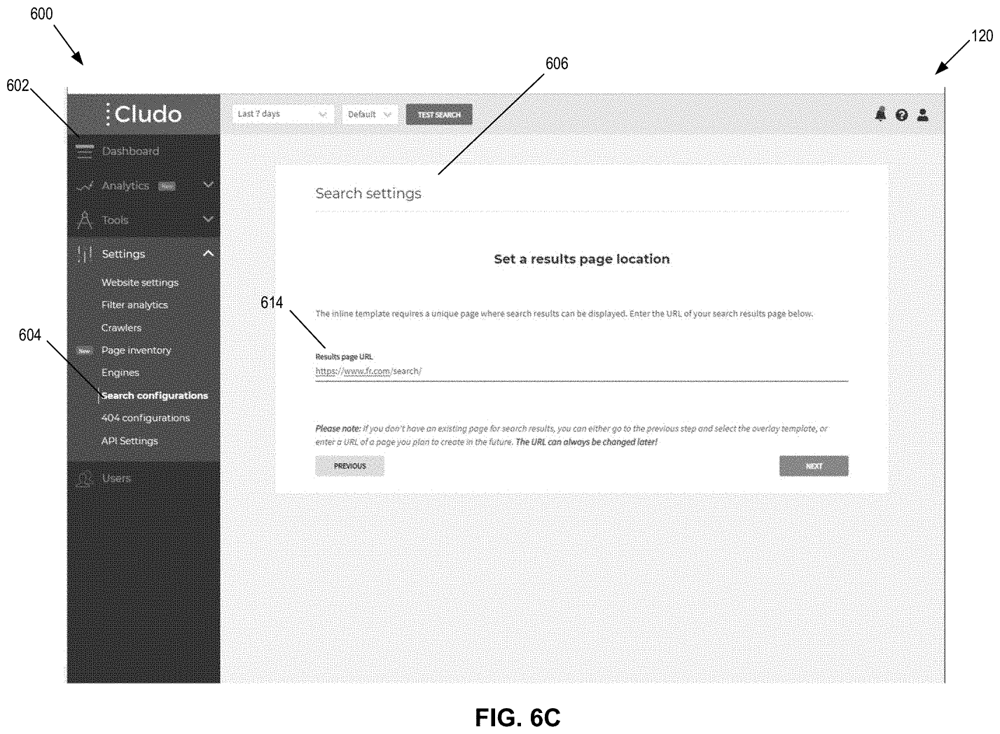

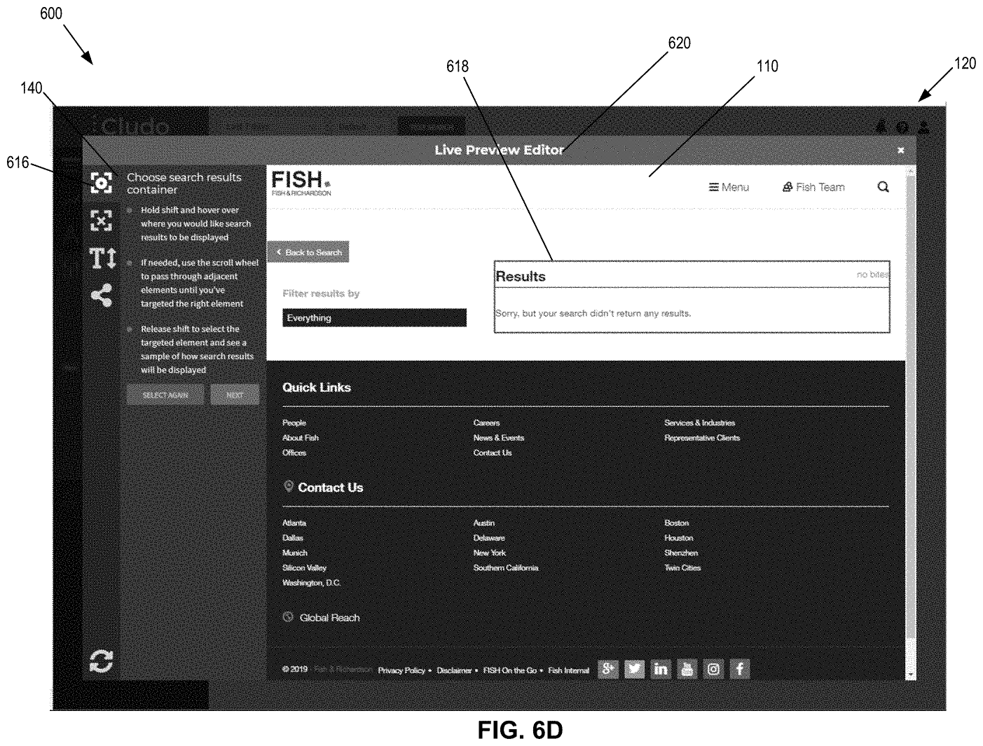

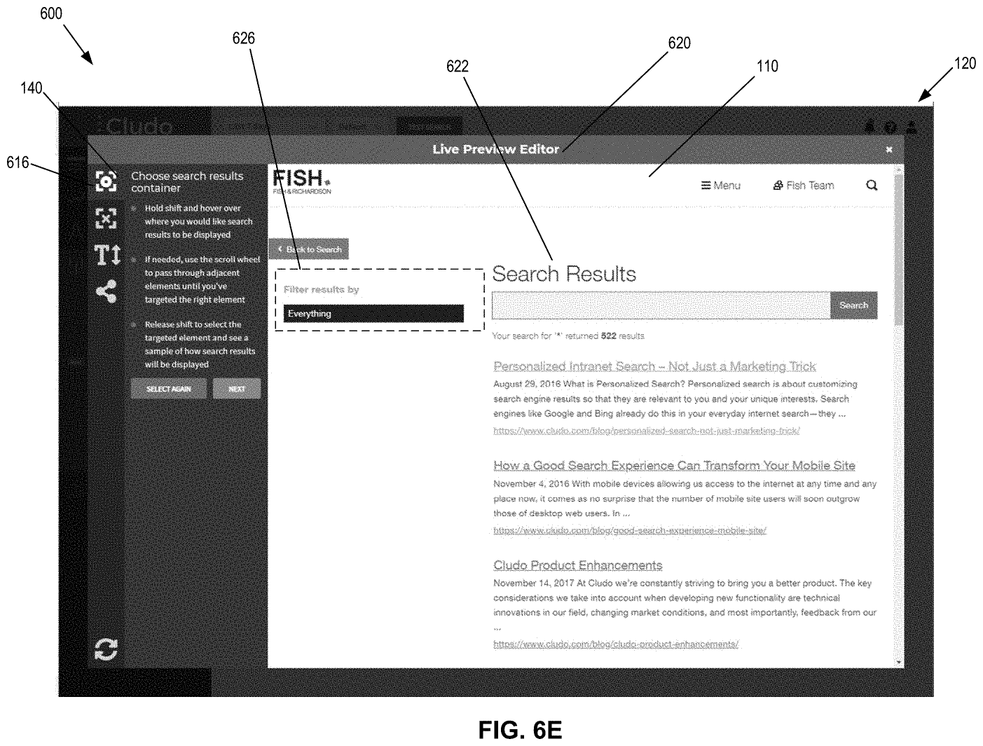

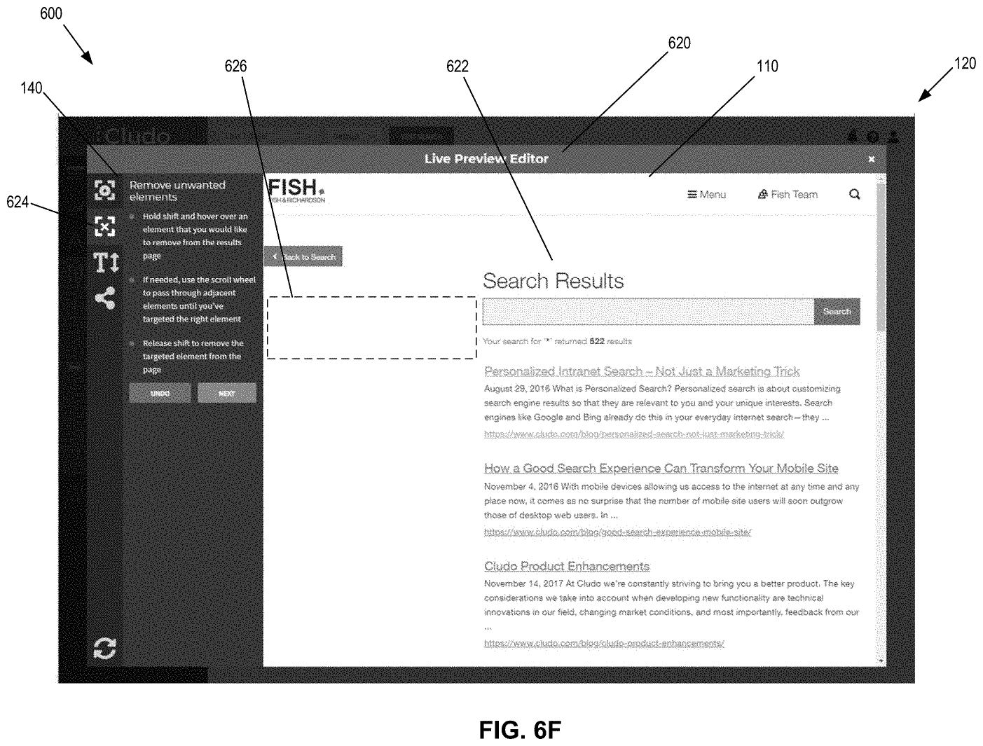

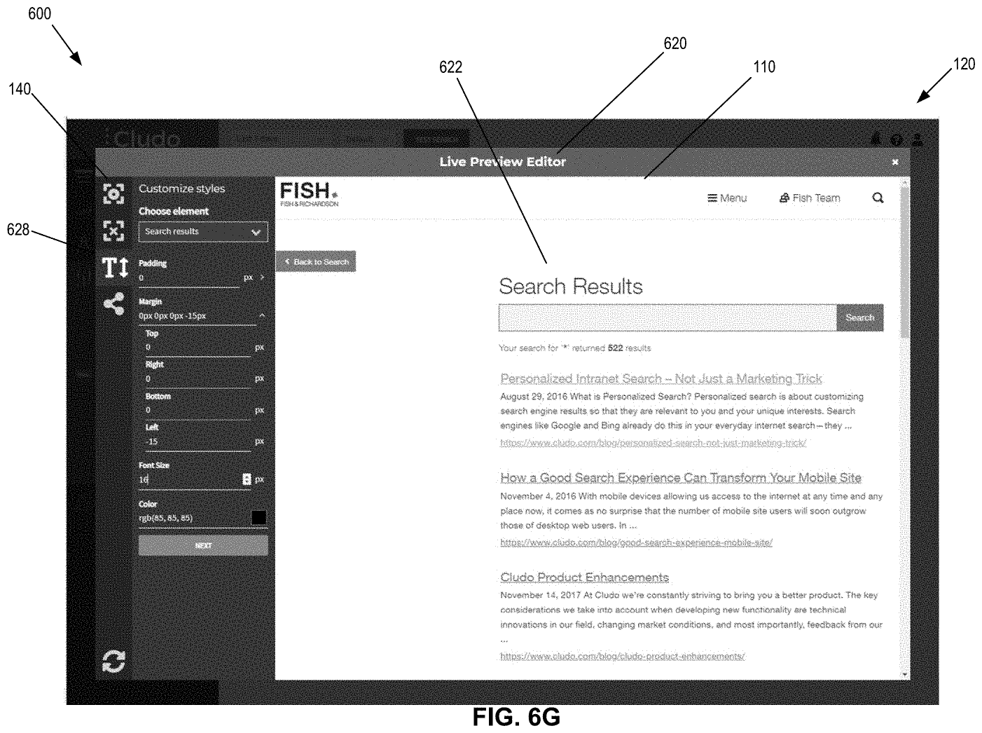

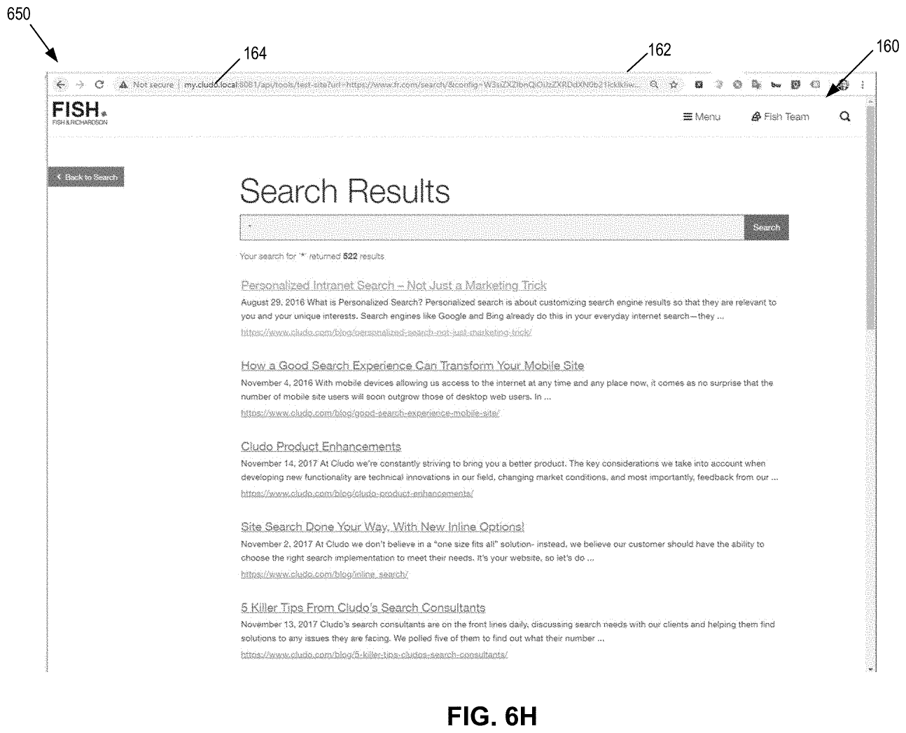

Referring still to FIG. 1A, the example system 100 generates a live site search preview 110 in a configuration mode. In the configuration mode, a configuration application 120 is launched on the client computing device 106 to provide the live site search preview 110 of a target website and enable a user to configure features associated with the site search shown in the live site search preview 110. In the configuration mode, the live site search preview 110 can be rendered and presented with the configuration application 120. For example, the configuration application 120 provides iframes for presenting the live site search preview 110 and for presenting a configuration panel 140 that can include features through which the site search preview 110 can be configured. For example, the configuration panel 140 can present control features (e.g., buttons, selectors, text boxes, sliders) through which a user can configure various attributes of the live site search preview 110, such as appearance and/or functionality, for inserting site search on the client's website The iframes that are loaded in the configuration application 120 can give the user the perception of viewing the client website and enable the user to interactively modify the website while monitoring such modification in real-time. Example interfaces of the configuration application 120 in the configuration mode are illustrated and described below with reference to FIGS. 6A-6G.

In some embodiments, the configuration application 120 is a web application that can be loaded on a web browser 142 running on the client computing device 106. A user can access the configuration application 120 using a URL 144. As described herein, the URL 144 can be a URL hosted by the site search server 104, and links for the site search preview 110 can link back to the site search server 104. Other types of the configuration application 120 are also possible in other embodiments, such as standalone applications that are installed on client devices (e.g., mobile applications).

As part of providing a live site search preview for the example target website in a configuration mode, the configuration application 120 can be launched on the client computing device 106. For example, the URL 144 is entered on a browser in the client computing device 106 by a user and sent from the client computing device 106 to the site search server 104 to access the configuration application 120 that is hosted by the site search server 104.

When the configuration application 120 is launched, the user can request a live site search preview of a target website in a configuration mode. In some implementations, the user can type in a URL for a target website on the configuration application 120, and the client computing device 106 can then transmit a configuration preview request to the site search server 104 (Step A). The configuration preview request can be a request that is sent to the site search server 104 and that includes the target website URL, which can prompt the site search server 104 to access the target website identified by the target website URL and hosted by the client web server 102. The target website URL is different from the URL 144 for the live preview service provided by site search server 104.

In Step B, in response to the site search server 104 having received the request from the client computing device 106 to initiate a site search preview for the target website, the site search server 104 communicates with the client web server 102 and makes a request for the target website URL passed from the client computing device 106. The request is transmitted to the client web server 102 to access the webpages 112 for the web site.

In Step C, in response to the request, the client web server 102 provides one or more webpages 112 to the site search server 104. Accessing the webpages can include, for example, the site search server 104 receiving one or more URLs to the website (e.g., URL for root webpage on website), requesting the webpage from the client web server 102, receiving the webpage, and then crawling the web site by, for example, recursively crawling the links provided in the webpages 112 for the website to identify additional pages to request. Once the site search server 104 has begun receiving the webpages 112 for the website from the client web server 102, the site search server 104 can begin scraping the content from the webpages 100 to generate and build a search engine and corresponding index for the website.

In Step D, the site search server 104 operates to augment and modify some aspects of the documents returned by the client web server 102 so that they can be properly rendered in the site search preview 110 when being transmitted from the site search server 104 (instead of from the webserver 102). For example, the site search server 104 (e.g., the API server 122) can update all relative link references to absolute link references to the resources on the client web server 102, thereby fixing resource issues that may result from webpages being served from site search server 104. Further, the site search server 104 (e.g., the API server 122) can add a supplementary live preview script (e.g., JavaScript) to run a live site script preview 110 and enable configuration. Moreover, the site search server 104 (e.g., the API server 122) can add reference to a site search script which is utilized by the liver preview script file.

In some embodiments, the site search server 104 can generate the index 132 of the website and its webpages, and stores the index 132 locally in the index database 128. The index 132 can include, for example, a data structure that organizes the content of the webpages 112 for the web site along one or more dimensions (e.g., associations between webpages 112 and search query terms). The index 132 can also include, for example, modifications and/or augmentations to the structure of data obtained from scraping the webpages 112, which may be directed (e.g., website owner identification of particular web page that is most relevant to particular search query) and/or inferred (e.g., correlation between search queries and particular web pages based on previous user behavior when receiving search results for the same or similar search queries).

The site search server 104 can use the index 132 to provide the live search functionality for the website that is used with the site search preview 110. In addition, the site search server 104 can store code for presenting the configuration application 120 on the client computing device 106. For example, the code for the configuration application 120 can, when interpreted/executed by the client device 106, presents an interface through which the user can customize and view the site search preview. In the configuration mode, the configuration application 120 can effectively acts as a wrapper for the modified webpage (i.e., the webpage 112 modified with the search script) generated by the site search server 104. As described herein, for example, the configuration application can be a web application that includes an iframe in which the modified webpage 112 is presented. As part of generating the live preview in step D, the site search server 104 accesses the API database 126, which can store, for example, the configuration application 120, APIs to provide site search functionality on the webpage 112, and/or other details.

In Step E, the site search server 104 transmits the live site search preview code to the client computing device 106. For example, the site search server 104 can provide the code for the configuration application 120 and the modified code (in Step D) for the web site hosted by the webserver 102 to the client computing device 106 for presenting the live site search preview 110. In addition, the site search server 104 can provide the client computing device 106 with any preexisting configuration data for customizing the site search interface and results for the web site. For example, a user may be able to edit previously generated site search configurations for a website, which may be stored on and retrieved from the site search server 104. As described herein, the configuration data can be generated on the client device 106 as a user customizes the site search features for the web site using the configuration application 120, and can be transmitted by the client device 106 to the site search server 104 for storage.

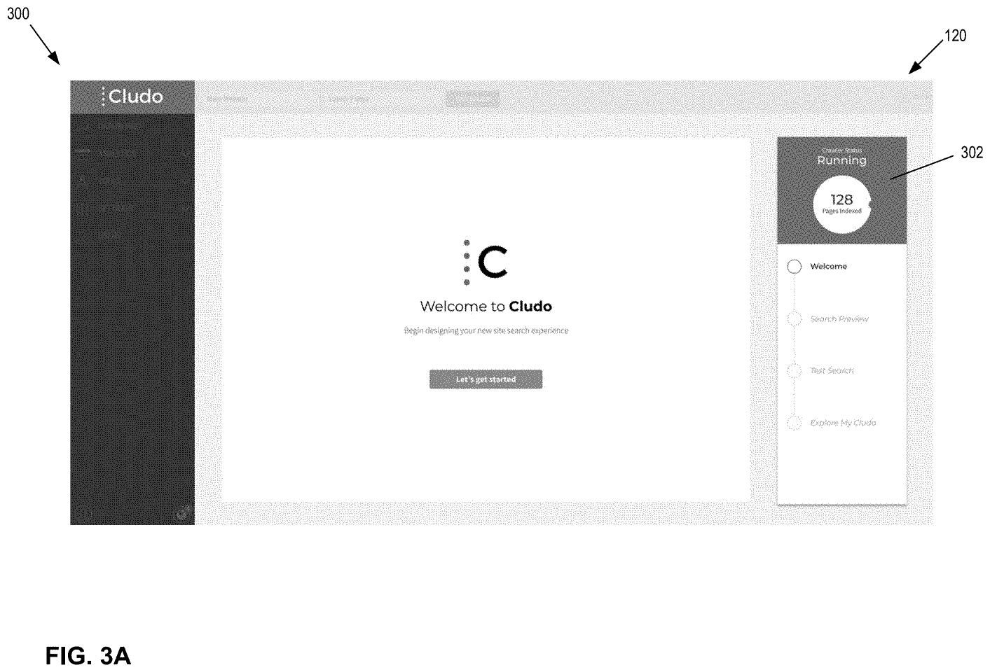

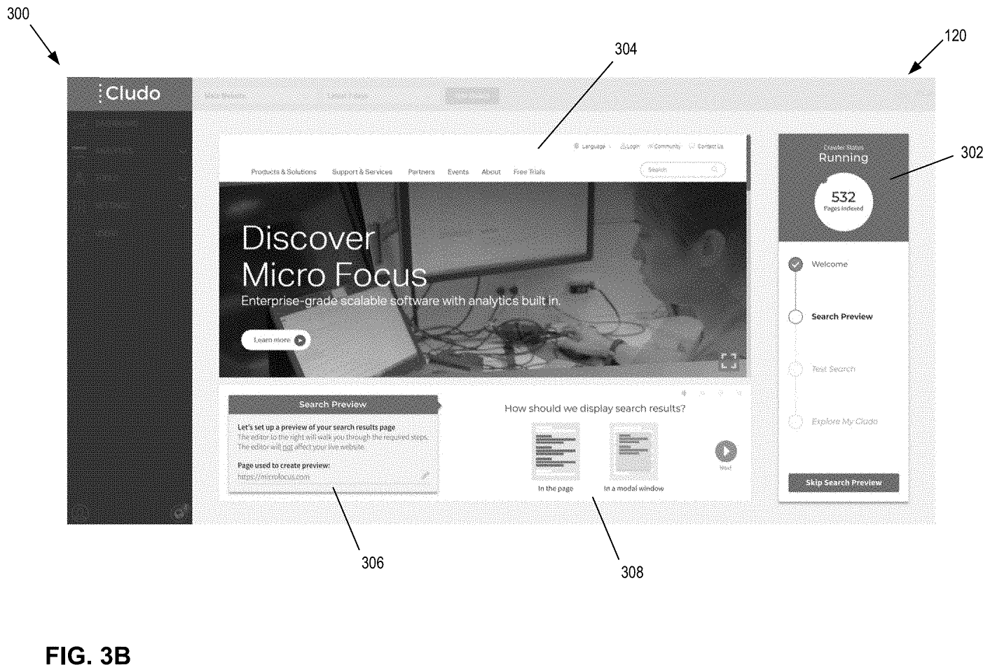

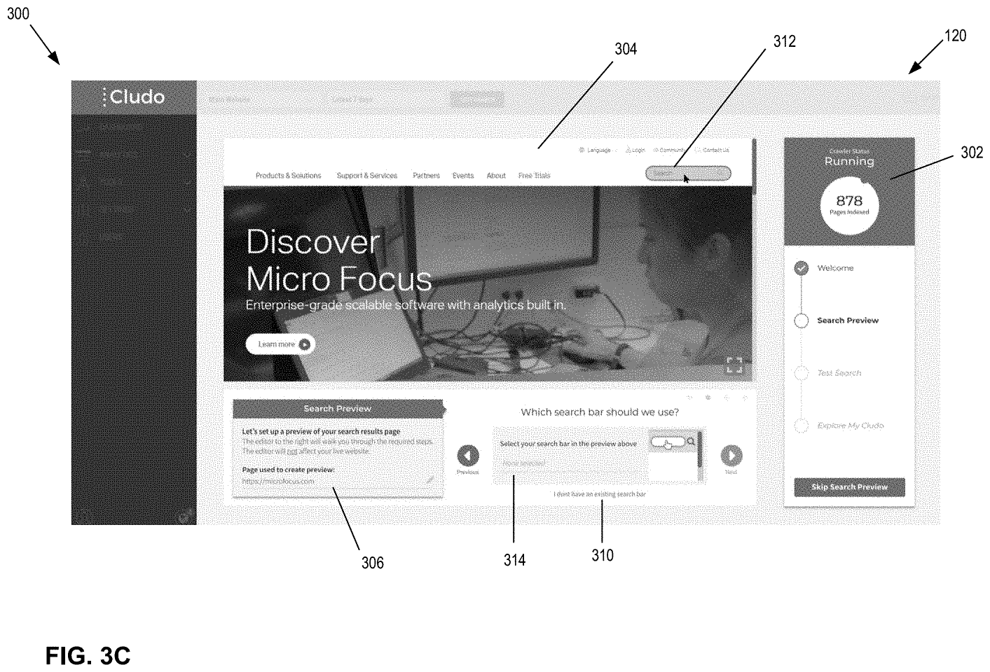

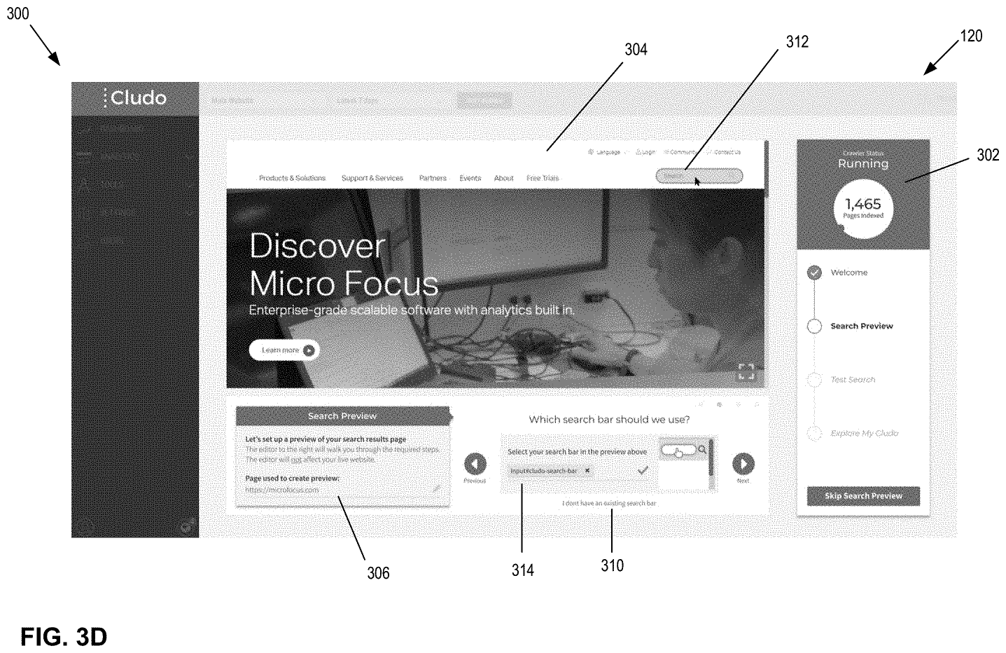

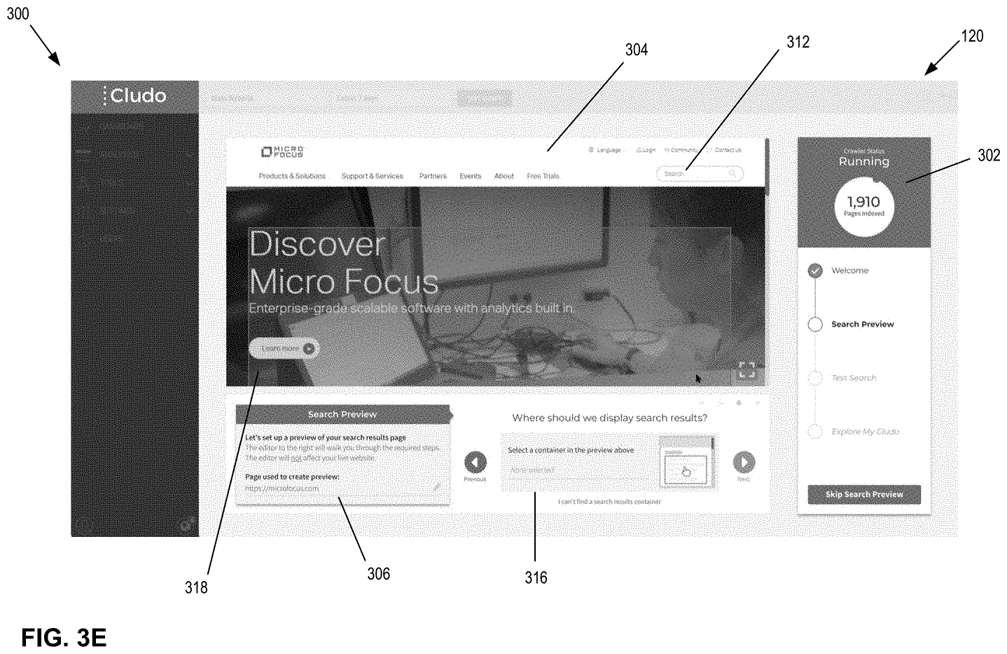

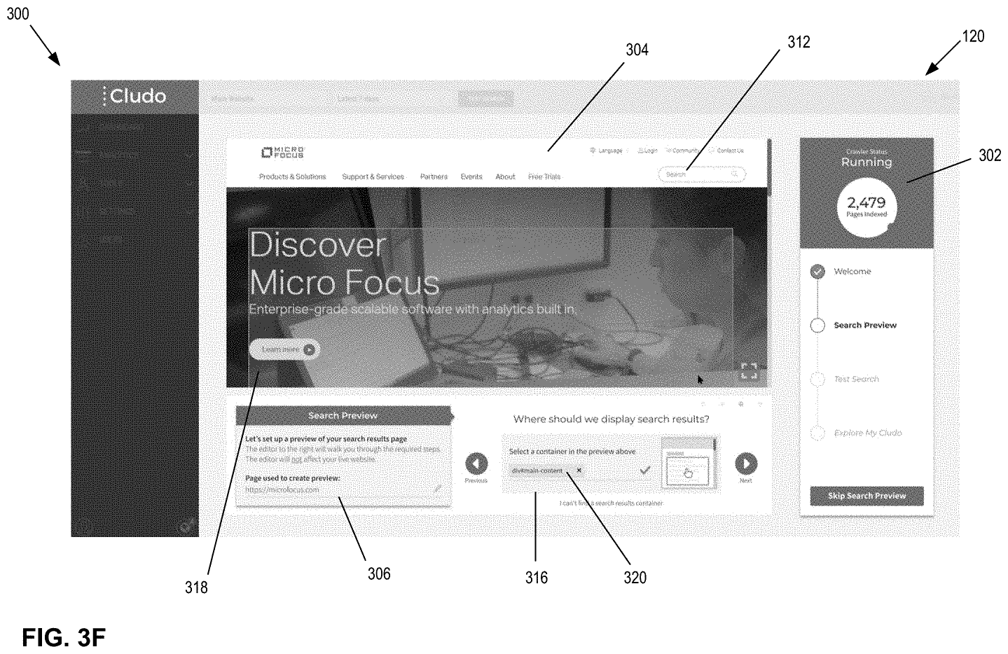

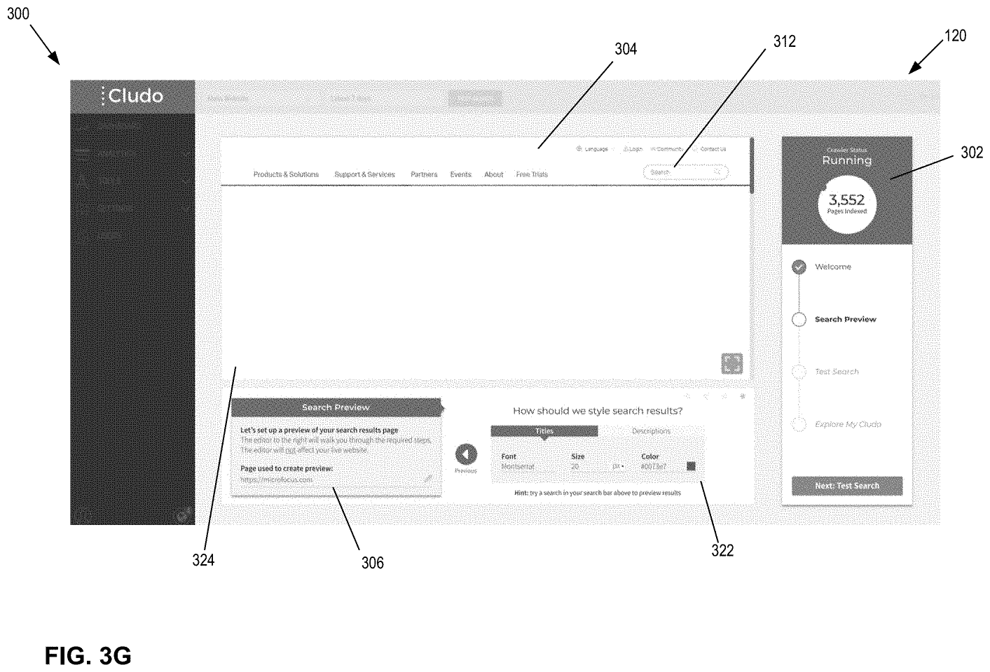

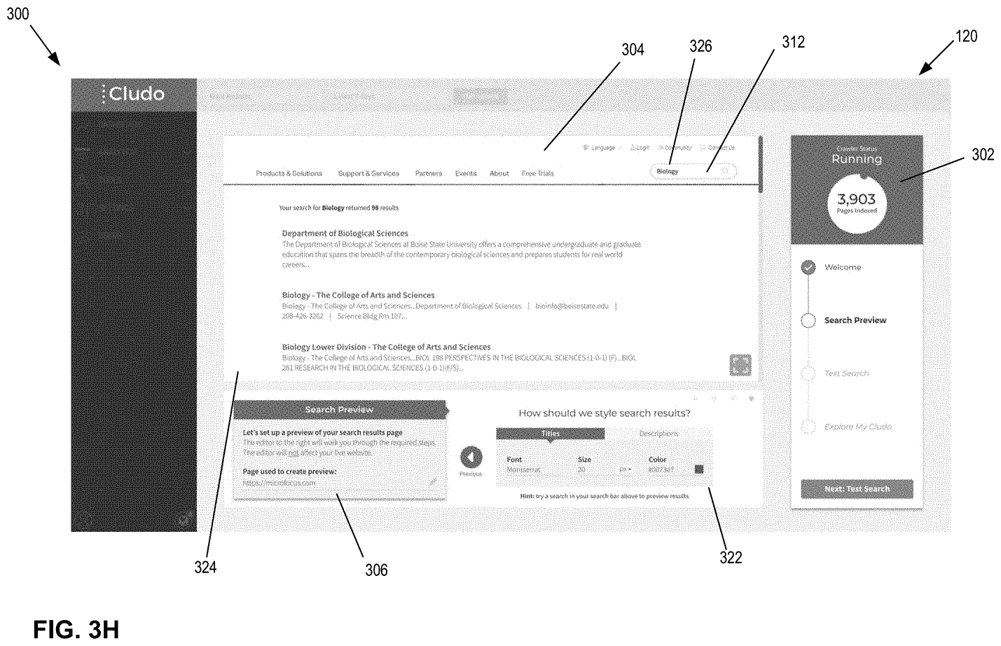

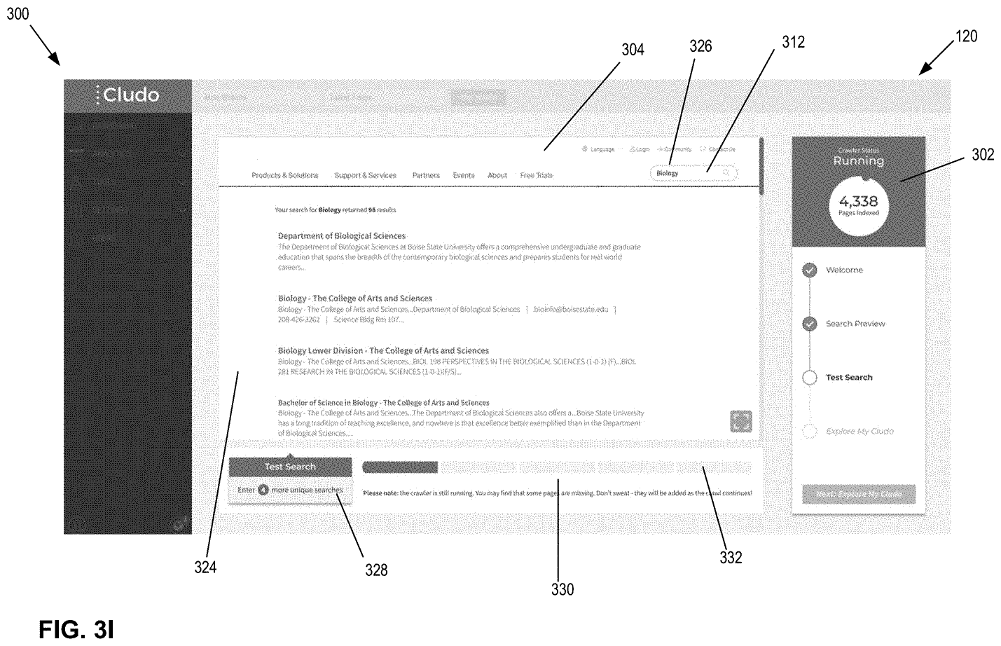

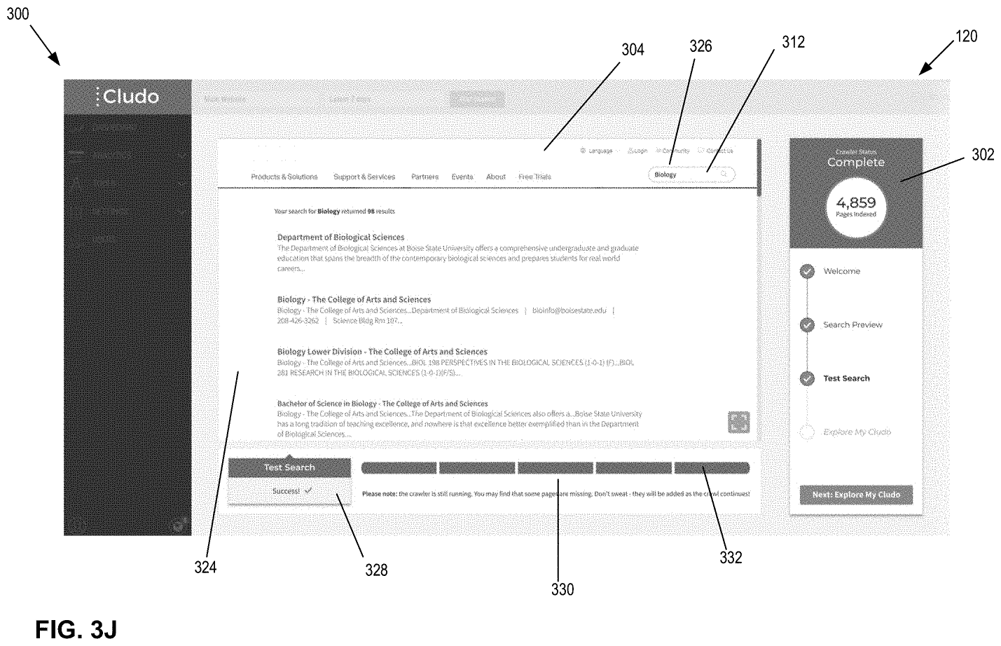

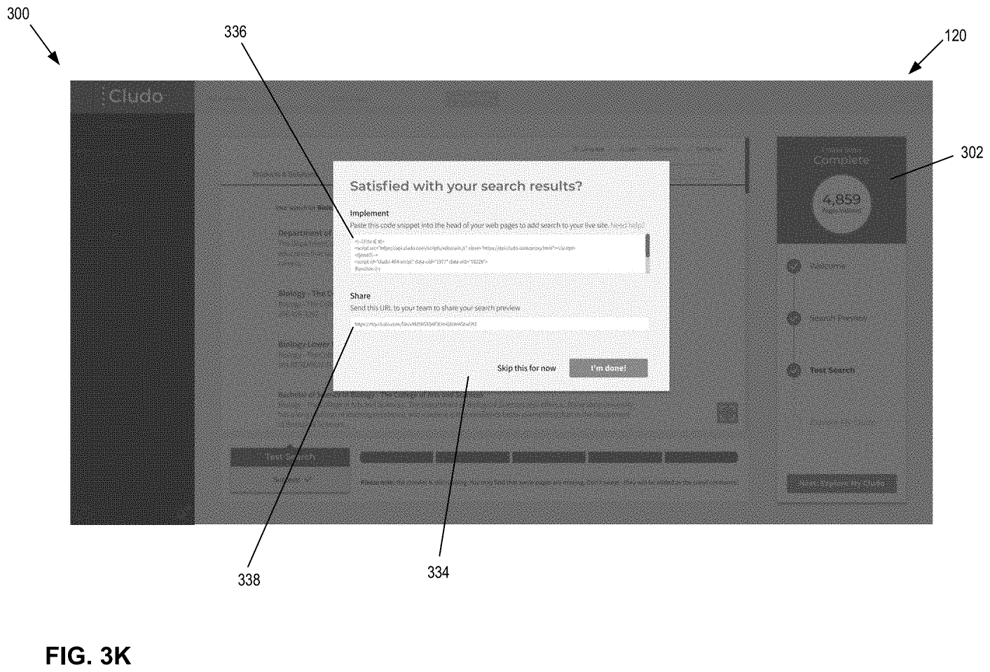

In Step F, the client computing device 106 configures the site search for the target website using the configuration application 120. Example user interfaces for the configuration application 120 are depicted in FIGS. 3A-K and 6A-H. The configuration application 120 can provide a number of guided steps that a user of the client computing device 104 can follow to place a search input field and search results container on the website, in addition to designating other site search parameters and configurations. The search input field can be, for example, a search bar or other input field through which a user can enter a site search query. The search results container can be one or more elements of the website where the search results are to be presented (e.g., search results replacing the one or more elements). These user designations can be used by the configuration application 120 being executed locally on the client computing device 104 as part of the site search preview 110 to further modify the webpage 112 to present the site search preview (e.g., dynamically modify DOM to present search input field and modified container at specified locations). These user designations can also be incorporated into the site search configuration for the website, which can be a file/document/data structure generated and maintained locally by the configuration application 120 on the client device 106. The site search configuration can, in some instances, be relayed back to the site search server 104, which can use them to customize the site search engine for the webpages 112 and to build a script hosted on the site search server 104 that can implement the site search on webpages 112 (e.g., implemented by linking to the script with, for example, a simple include statement). Once the input field and the search results container have been designated, the client computing device 106 can receive search queries (e.g., test queries) from a user via the site search preview 110 and can transmit them to the site search server 104, which can process the search queries using the index being concurrently generated (e.g., in Step D) and provide site search results to the client computing device 106 of presentation to the user in the site search preview 100.

The configuration application 120 can permit a user to make changes (e.g., modifications) to the site search configurations at the client computing device 106, which can be incorporated into the local copy of the site search configuration data on the client computing device 106 and, in some instances, relayed to the site search server 104 to provide a configurable live updated preview 110 on the client computing device 106. In some embodiments, while the site search server 104 is scraping the website associated with webpage 112, the site search server 104 can also scrape style sheets of the website associated with webpage 112 and create a default style for the search results, based on those style sheets. In one example, if the user at the client computing device 106 does not like the default style of preview 110, the user can modify at least one or more of a style, font, and size of the search results. Once the user makes these modifications, the site search server 104 updates the site search preview 110 with the user modifications, presents to the user a live, updated preview 110, and stores the site search code and/or configurations to reflect the modifications (e.g., changes). For example, the code and/or configurations can be stored in the API database 126 and/or the configuration database 130.

In the configuration mode, the preview 110 can be displayed within the frame of the configuration application 120. The configuration application 120 further provides the configuration panel 140 that permits a user to navigate, update, and customize the appearance of the search results on the webpage 112 in the live site search preview 110. The configuration panel 140 in the configuration application 120 is configured to allow the user to configure the site search on the target website. With the supplementary live preview script added at Step D, the configuration application 120 can communicate with the live site search preview 110 to allow dynamic configuration and content updating. For example, the live site search preview 110 can access the site search configuration for the website that is being generated and updated by the configuration application 120, and can use the site search configuration to dynamically update website preview that is being presented in the site search preview 110 in response to the configurations made via the configuration panel 140.

Configuration data is generated as the user configures the site search in the configuration preview mode. The configuration data generated during the configuration preview mode can be utilized both for implementing a configuration preview mode later in time and for implementing a standalone preview mode where the modified site search is displayed in the standalone preview mode. In this sense, the configuration data is a shared configuration object utilized by both the configuration preview mode and the standalone preview mode. In some embodiments, the shared configuration data can be represented in an encoded JSON format. The configuration data can be used to reproduce and configure the site search on the client website. The configuration data is configured and used for a site search preview (either the configuration preview mode or the standalone preview mode) and a site search on the website in runtime.

The site search configuration data can be passed between devices in any of a variety of ways. For example, the site search configuration data can be a document (e.g., JSON file, script, config file) that can be transmitted between devices, such as via a URL that identifies the document and can be used to request transmission of the document. In another example, the site search configuration data can be appended to a URL as query strings and/or arguments. In another example, the site search configuration data can be incorporated within other documents, such as being contained within scripts, markup documents, and/or other files that are provided as part of the website. The configuration data can be passed between the configuration mode to the standalone mode using any of these techniques, such as the configuration data being incorporated in a URL for the standalone preview mode hosted by the site search server 104. In such instances, the configuration data is stored on the client device 106 and simply appended to a URL for standalone mode that can be readily shared between users and devices, which can enable the standalone preview to be provided without transmitting the configuration to and back from the site search server 104.

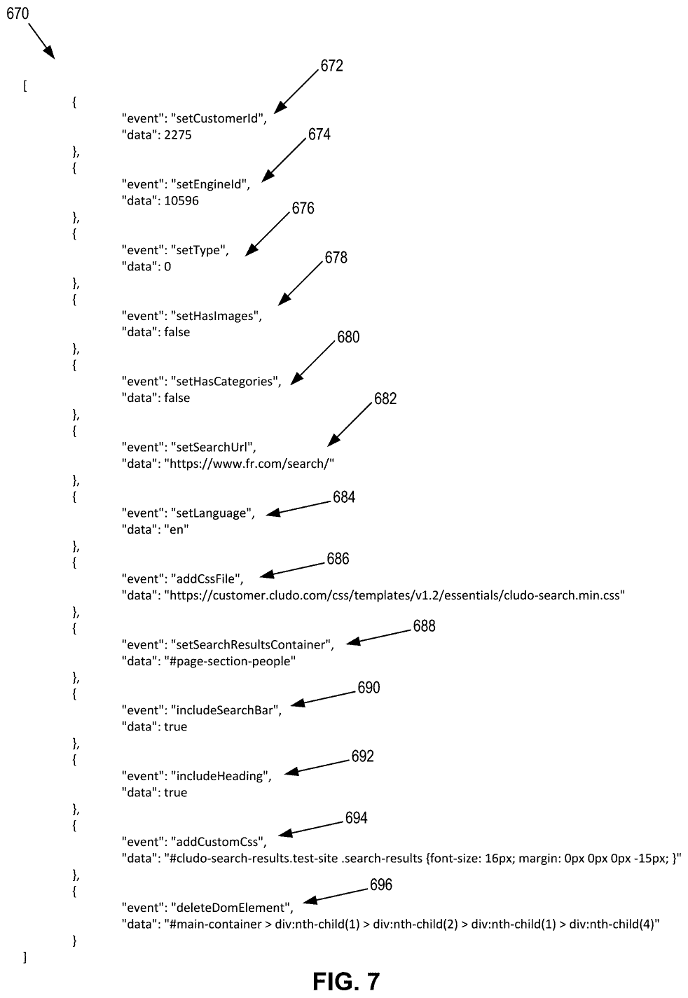

Additionally and/or alternatively, the configuration data may be configured to further support other functionalities that can be applied to other use cases (in addition to or instead of site search previews) to manipulate a DOM via script or instruction. Example functions that the configuration data can support include (1) deleting a DOM element, (2) adding a DOM element, (3) adding a script, (4) adding a stylesheet, (5) replacing an element value, (6) calling a function on load, and other functionalities that can be accomplished via a script (e.g., JavaScript) that is maintained and loaded by the site search server. In particular, the configuration data can be configured to, for example, (1) delete an element from the DOM by passing in a query selector for the element to be removed; (2) pass in a query selector of parent and code (e.g., HTML) to add (e.g., this will add the passed in the code to the DOM in the query selector that was passed in); (3) add a script reference to the DOM using a script URL defined in the configuration; (4) configure adding stylesheets via configuration; (5) replace the contents/value of a particular content; and (6) call a defined function once the page has loaded. An example of the configuration data is described in further details with reference to FIG. 7.

In Step G, the configuration data generated using the configuration panel 140 can be transmitted from the client computing device 106 to the site search server 104. The configuration data can be saved as a configuration object 134 in the configuration database 130. The configuration object 134 can be created and updated as the configuration changes on the client computing device 106. The configuration object 134 can be retrieved and used in runtime to provide the customized site search on the website. Further, the configuration 134 can be retrieved and used to provide live site search previews in either a configuration mode or a standalone mode. In some embodiments, the configuration can be serialized into a single value that is reproducible in a standalone format, or in the configuration application for further configuration. By way of example, the configuration object is a base64 encoded JSON string. Other types of the configuration object is also possible.

Alternatively, the configuration data generated via the live site search preview 110 on the client computing device 106 can be added to a URL for the standalone mode of live site search preview as described herein, and/or added to a URL for the target website (the website URL). In this embodiment, the configuration data can be stored on the client side, and does not have to be stored in the site search server 104. The URL that stores the configuration data can be used to retrieve the live site search preview in the standalone mode as described with reference to FIG. 1B. In some embodiments, URL shorting is used to simplify the website URL that incorporates the configuration.

Although the Steps A-G are presented as being sequential, they are preformed - and in parallel in other embodiments.

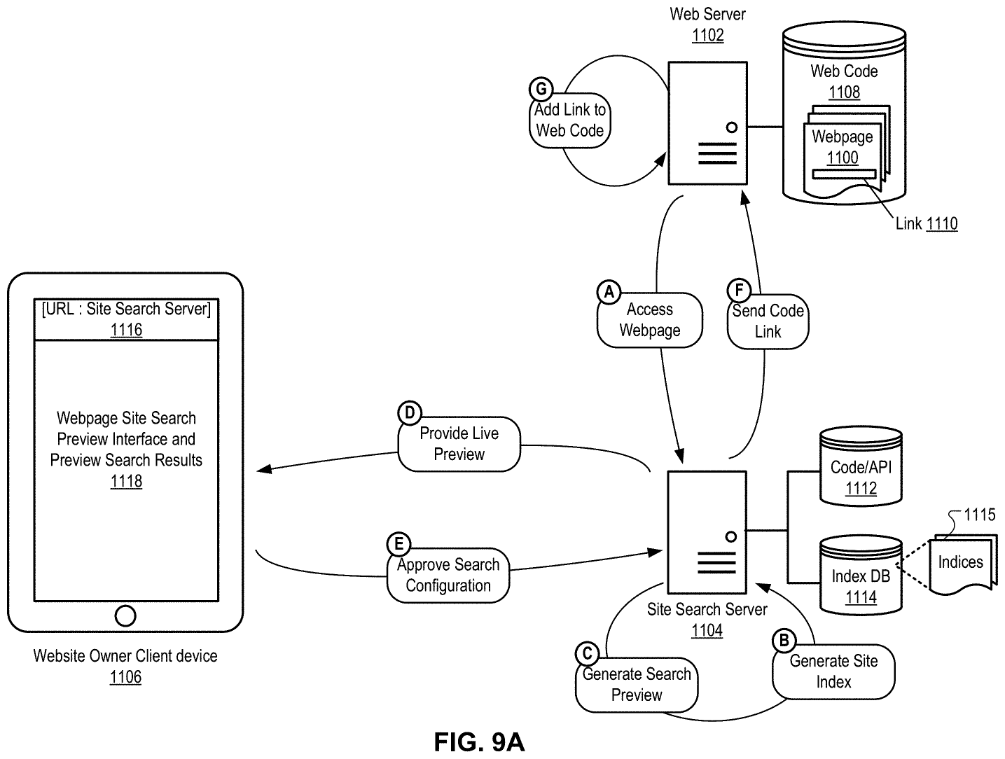

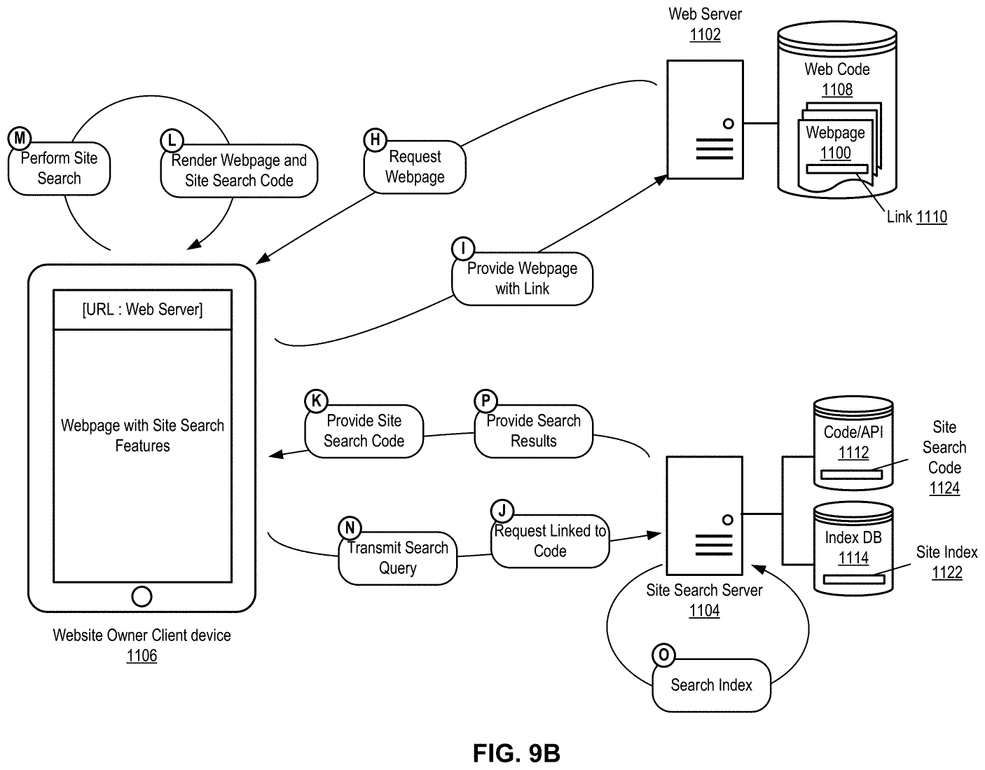

Once the search results have been presented and previewed in the configuration application 120, the configuration application 120 can provide an option for a user to approve and deploy the site search functionality hosted by the site search server 104 on the website and its webpages 112. In response to the client computing device 106 having approved the deployment of the site search with the site search server 104, the site search server 104 can generate a link to the site search code and the configuration data. As discussed herein, the site search code and the configuration data can be updated to reflect any changes made to the live site search preview 110 and/or the search engine by the user at the client computing device 106. Once all user customizations are complete and the site search preview 110 is approved, the site search server 104 can generate the link for inclusion in the web code of the website that is served by the client web server 102. For example, a user of the client computing device 106 can modify the underlying code for the website to include the link to the site search code and the configuration to implement the site search functionality that was previewed and finalized via the site search server 104. Thus, the client web server 102 can link to the site search code and the configuration object. When a second client computing device requests access to a webpage 112, the client web server 102 serves the code of the webpage 112 with the link, which is interpreted by the second client device to request the site search code and the configuration object from the site search server 104 to provide the improved site search functionality for the website on the second client computing device. An example of this interaction with a second client device is described below with regard to FIG. 9B.

Referring now to FIG. 1B, this figure is a block diagram illustrating the system 100 that generates a live preview in a standalone mode. In the standalone mode, a live site search preview 160 is rendered outside the context of the configuration application 120. In the standalone mode, the live site search preview 160 is created to give a user the perception that the user interacts directly with the client website that has been modified to incorporate the site search functionality hosted by the site search server 104. The standalone mode of the live site search preview can be shared with other users to, for example, demonstrate the site search incorporated in the website.

The standalone mode of the live site search preview 160 can be rendered upon a user request for a standalone preview mode, such as by selecting a standalone preview mode option on an application (e.g., the configuration application 120) running on the client computing device 106, or by inputting a site search URL for the client website (e.g., the webpage 112 that incorporates the site search). For example, when a user selects a standalone preview mode option, a URL 164 associated with the selected standalone preview mode option is sent from the client computing device 106 to the site search server 104 (Step A). In another example, the URL 164 can be directly entered on a browser 162 in the client computing device 106. In some embodiments, the URL 164 for the site search server 104 includes the website URL. In other embodiments, the URL 164 for the site search server 104 includes not only the website URL but the configuration data as well.

In response to the URL request, the site search server 104 can communicate with the client web server 102 to access the target webpage 112 from the web code database 114 in Steps B and C. Steps B and C in the standalone mode are performed similarly to Steps B and C in the configuration mode described in FIG. 1A.

Alternatively, in response to the URL request, the site search server 104 can retrieve the target webpage from the webpages stored in the site search server 104 (e.g., in the API database 126) that have been cached for the target website during, for example, the configuration mode as described in FIG. 1A. In this embodiment, the site search server 104 does not have to communicate with the client web server 102 to access the target webpage from the web code database 114.

In Step D, the site search server 104 performs the operations similar to the operations in Step D of the configuration mode as described in FIG. 1A. In addition, the site search server 104 operates to identify the configuration object 134 that is associated with the target website (or its one or more webpages 112). As described herein, the configuration object 134 can be generated to reflect the user customization of the site search in the configuration mode, and stored in the configuration database 130. The site search server 104 can retrieve the configuration object 134 from the configuration database 130 that matches the target website.

In Step E, the site search server 104 transmits the live site search preview code to the client computing device 106. For example, the site search server 104 can provide the modified code (in Step D) to the client computing device 106 for presenting the live site search preview 110. The live site search preview code is designed to generate a site search preview in the standalone mode as described herein.

In embodiments where the configuration data that has been generated in the configuration mode have been incorporated to the URL, the configuration data does not have to be stored in the site search server 104, and the site search server 104 does not have to transmit such configuration data to the client computing device 106 for rendering the site search preview.

However, in alternative embodiments where the configuration data are stored in the site search server 104, the site search server 104 can transmit the configuration data (e.g., configuration object 134), which was retrieved by the site search server 104, to the client computing device 106. The configuration object 134 includes data that are used to generate the appearance of the webpage with the site search interface and results as customized by the user via the site search preview 110 in the configuration mode.

In Step F, the client computing device 106 operates to generate a site search preview 160 in the standalone mode using the live preview code transmitted in Step E. In addition, the client computing device 106 operates to decode the configuration data, and apply it to the site search preview 160 in the standalone mode, so that the site search preview displays the site search that has been customized by the user. by the site search server 104 within only the context of the target website, instead of using an iframe (e.g., within the frame of the configuration application 120). Therefore, the site search preview 160 in the standalone mode is displayed as if the site search is actually performed within the target website. For example, the standalone mode can be used to provide a fully functional demo of the site search before the site search is officially launched in the target website.

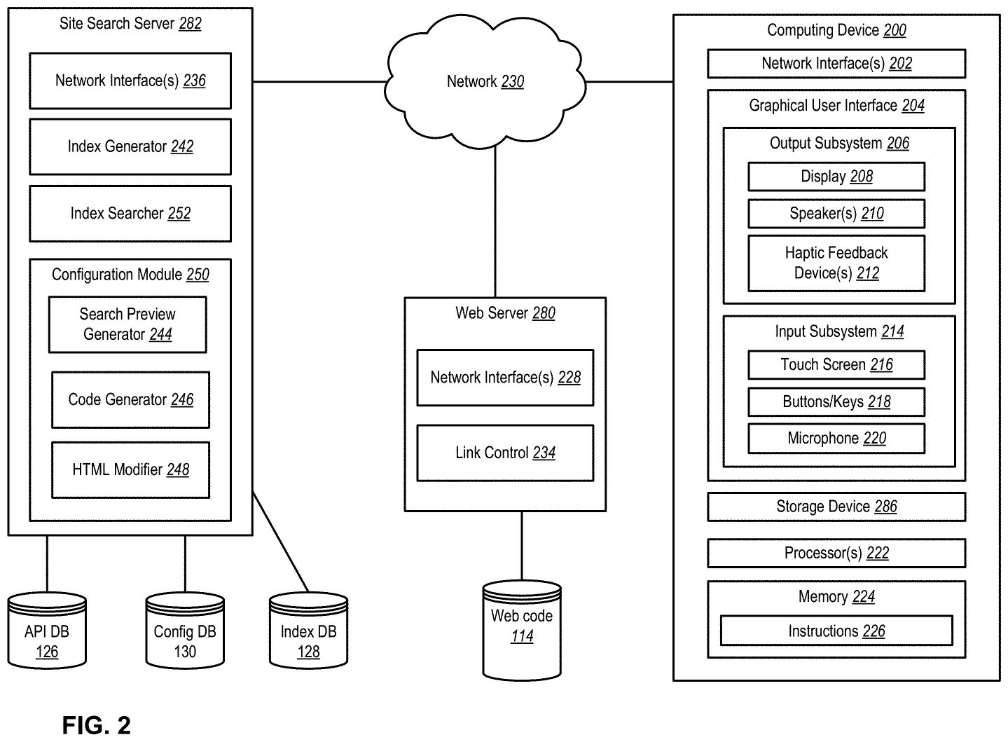

FIG. 2 is a block diagram illustrating an example network system comprising one or more computing devices and one or more servers configured to communicate with each other over a network, according to one implementation of the present disclosure. FIG. 2 includes computing device 200 as well as servers 280 and 282 that may be used to implement the systems and methods described in this disclosure. Computing device 200 can be any of a variety of mobile devices, such as personal digital assistants, cellular telephones, smartphones, and other computing devices. Computing device 200 can also be any of a variety of non-mobile devices, such as digital computers, including laptops, desktops, workstations, and other appropriate computers. Servers 280 and 282 can be any of a variety of digital computers, such as laptops, desktops, workstations, personal digital assistants, servers, blade servers, mainframes, and other appropriate computers. Servers 280 and 282 can be any of a variety of other typically non-mobile devices, such as televisions or other electronic devices with one or more processors embedded therein or attached thereto. The components shown here, their connections and relationships, and their functions, are meant to be examples only, and are not meant to limit implementations of the invention described and/or claimed in this disclosure.

Computing device 200 (e.g., a user client device in one embodiment or a website owner client device in another embodiment), includes one or more network interfaces 202, a graphical user interface 204 (e.g., GUI, UI, or user interface) with an input subsystem 214 and an output subsystem 206, one or more processors 222, memory 224, and a storage device 286, among other components. Each of the components 202, 204, 222, 214, 206, 224, and 286 are interconnected using various busses, and may be mounted on a common motherboard or in other manners as appropriate.

The one or more processors 222 can process instructions 226 for execution within computing device 220, including instructions stored in the memory 224 or on the storage device 286 to display graphical information for a GUI or graphical user interface 204. The graphical user interface 204 may include an input device, such as a keypad, keyboard, touch screen, or other device that can accept user information, and an output device that conveys information associated with the operation of computing device 200, including digital data, visual, or audio information (or a combination of information), or a graphical-type user interface (UI or GUI). In other implementations, multiple processors may be used, as appropriate, along with multiple memories and types of memory. The processor may also include separate analog and digital processors. The processor may provide, for example, for coordination of the other components of the computing device 200, such as control of user interfaces, applications run by computing device 200, and wireless communication by computing device 200.

Processor 222 may communicate with a user through the graphical user interface 204. The output subsystem 206 includes a display 208, one or more speakers 210, and one or more haptic feedback devices 212 that are able to provide haptic feedback (e.g., vibrations, other non-visual sensations) to a user. The display 208 may be, for example, a TFT LCD display or an OLED display or other appropriate display technology. The output subsystem 206 may comprise appropriate circuitry for driving the display 208 to present graphical or other information to a user. Computing device 200 may also communicate audibly using speaker 210, which may generate audible sound, using audio codec (not shown), for a user. In another implementation, speaker 210 may be a handset of computing device 200. The sound may include sound from voice telephone calls, recorded sound (e.g., voice messages, music files, spoken information from the user, etc.) and sound generated by applications operating on computing device 200.

The input subsystem 214 may receive commands from a user and convert them for submission to the processor 222. The input subsystem 214 may include a touch screen 216, buttons and/or keys 218, and microphone 220. The input subsystem 214 in one embodiment, for example, may only include touch screen 216 or just buttons and/or keys 218 or just microphone 220. The input subsystem 214 may include, in one embodiment, all or at least one of the touch screen 216, the buttons and/or keys 218, and the microphone 220. Computing device 200 may also communicate audible using microphone 220, which may receive spoken information from a user and convert it to useable digital information, using audio codec (not shown). In another implementation, microphone 220 may be a handset of computing device 200. The sound may include sound from voice telephone calls, recorded sound (e.g., voice messages, music files, spoken information from the user, etc.) and sound generated by applications operating on computing device 200. In one implementation, the buttons and/or keys 218 may be a QWERTY keyboard directly on the computing device 200 or attached externally to the computing device 200. For example, the buttons and/or keys 218 in a QWERTY keyboard may be connected to the computing device 200 by Bluetooth®, a USB, or other such technologies and modes of connection between computing device 200 and external devices.

In addition, an external interface (not shown) may be provided in communication with processor 222, so as to enable near area communication of computing device 200 with other devices. The external interface (not shown) may provide, for example, for wired communication (e.g., through a docking procedure) or for wireless communication (e.g., through ^{Bluetooth}® or other such technologies).

Computing device 200 is communicably coupled with network 230 and can communicate wirelessly or wired through network interface 202, which may include digital signal processing circuity where necessary. Network interface 202 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through a transceiver (not shown, e.g., a radio-frequency transceiver). In addition, short range-communication may occur, such as using a Bluetooth®, WiFi, or other such transceiver (not shown). In addition, a GPS receiver module (not shown) may provide additional wireless data to computing device 200, which may be used as appropriate by applications running on computing device 200. In some implementations, one or more components of computing device 200 may be configured to operate within environments, including cloud-based computing, local, global, or other environments (or a combination of environments).

Memory 224 stores information within computing device 200. In one implementation, memory 224 is a computer-readable medium. In another implementation, memory 224 is a volatile memory unit or units. In yet another implementation, memory 224 is a non-volatile memory unit or units. Expansion memory (not shown) may be provided and connected to computing device 200 through an expansion interface (not shown), which may include, for example, a subscriber identification module (SIM) card interface. Such expansion memory may provide extra storage space for computing device 200, or may store applications or other information for computing device 200. Specifically, expansion memory may include instructions to carry out or supplement the processes described above, and may include secure information. Thus, for example, expansion memory may be provided as a security module for computing device 200, and may be programmed with instructions that permit secure use of computing device 200. In addition, secure applications may be provided via the SIM cards, along with additional information, such as placing identifying information on the SIM card in a non-hackable manner.

Memory 224 may include, for example, flash memory and/or MRAM memory. In one implementation, a computer program product is tangibly embodied in an information carrier. The computer program product contains instructions that, when executed, perform one or more methods, such as those described above. The information carrier is a computer- or machine-readable medium, such as memory 224, expansion memory, or memory on processor 222.

The storage device 286 is capable of providing mass storage for computing device 200. In one implementation, the storage device 286 is a computer-readable medium. In various different implementations, the storage device 286 may be a floppy disk drive, a hard disk drive, an optical disk drive, a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described in the present disclosure. The information carrier is a computer- or machine-readable medium, such as memory 224, the storage device 286, or memory on one or more processors 222.

Computing device 200 may be implemented in a number of different forms, as shown in FIG. 2. For example, it may be implemented as a cellular telephone (not shown). It may also be implemented as part of a smartphone, personal digital assistant, laptop, or other mobile or non-mobile device (not shown).

Web server 280 includes one or more network interfaces 228, a frontend 232, a backend 233, a link control module 234, and access to web code database 108. In this example, web server 280 access webpages 100 that are requested by client devices on a network. Each of the components 228, 232, 233, 234, and 108 may be interconnected using various buses, and may be mounted on a common motherboard or in other manners as appropriate. Connection with web code database 108 may occur wirelessly or through the network interface 228 and the network 230. Server 280 is communicably coupled with network 230 and can communicate wirelessly or wired through network interface 228, which may include digital signal processing circuity where necessary. Network interface 228 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through a transceiver (not shown, e.g., a radio-frequency transceiver). In addition, short range-communication may occur, such as using a Bluetooth®, WiFi, or other such transceiver (not shown). In addition a GPS receiver module (not shown) may provide additional wireless data to the server 280, which may be used as appropriate by applications running on server 280. In some implementations, one or more components of server 280 may be configured to operate within environments, including cloud-based computing, local, global, or other environments (or a combination of environments).

Server 280 may receive requests over network 230 from a client application (for example, executing on computing device 200). Server 280 may process and respond to the requests by using an appropriate software application(s). In addition, requests may be sent to server 280 from internal users (for example, from a command console or by other appropriate access methods), external or third-parties, other automated applications, as well as any other appropriate entities, individuals, systems, or computers.

Each component of server 280 may communicate using a system bus (not shown). In some implementations, any or all of the components of server 280, hardware or software (or a combination of both hardware and software), may interface with each other and/or the frontend 232 over the system bus, using an application programming interface (API). The API may include specifications for routines, data structures, and object classes. The API may be either computer-language independent or dependent and refer to a complete interface, a single instruction, or even a set of APIs. Server 280 may have software written in JAVA, C++, Javascript, or another suitable language providing data in extensible markup language (XML) format or other suitable format.

Server 280 may be implemented in a number of different forms and/or virtualized. For example, it may be implemented as a standard server 280, or multiple times in a group of such servers. It may also be implemented as part of a rack server system. In addition, it may be implemented in a personal computer, such as a laptop computer. Server 280 may include components from computing device 200, including the graphical user interface 204, comprising the output subsystem 206 with display 208, speaker 210, and haptic feedback device 212, and further comprising the input subsystem 214 with touch screen 216, buttons and/or keys 218, and microphone 220, as well as the storage device 286, processor 222, and memory 224. All of these components implemented in server 280 may perform as described above in the present disclosure. Alternatively, components from server 280 may be combined with other components in a mobile device (not shown), such as computing device 200. Each of such devices may contain one or more of computing device 200 as well as servers 280 and 282, and an entire system may be made up of multiple computing devices 200 as well as servers 280 and 282 communicating with each other. Also, multiple servers 280 may be connected, with each device providing portions of the necessary operations (e.g., as a server bank, a group of blade servers, or a multi-processor system).

Site search server 282 includes one or more network interfaces 236, a frontend 238, a backend 240, an index generator 242, component 250 comprising a search preview generator 244, a code generator 246, and an HTML modifier 248, as well as an index searcher 252. Server 282 further has access to code and APIs database 112 and index database 114. In this example, site search server 242 generates the improved search engine for each of the webpages 100 hosted by the web server 280. Each of the components 236, 238, 240, 242, 250, 244, 246, 248, 252, 112, and 114 may be interconnected using various buses, and may be mounted on a common motherboard or in other manners as appropriate. Connection with the code and APIs database 112 and index database 114 may occur wirelessly or through the network interface 236 and the network 230. Server 282 is communicably coupled with network 230 and can communicate wirelessly or wired through network interface 236, which may include digital signal processing circuity where necessary.

Network interface 236 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through a transceiver (not shown, e.g., a radio-frequency transceiver). In addition, short range-communication may occur, such as using a Bluetooth®, WiFi, or other such transceiver (not shown). In addition a GPS receiver module (not shown) may provide additional wireless data to the server 282, which may be used as appropriate by applications running on server 282. In some implementations, one or more components of server 282 may be configured to operate within environments, including cloud-based computing, local, global, or other environments (or a combination of environments).

Server 282 may receive requests over network 230 from a client application (for example, executing on computing device 200). Server 282 may process and respond to the requests using an appropriate software application(s). In addition, requests may be sent to server 282 from internal users (for example, from a command console or by other appropriate access method), external or third-parties, other automated applications, as well as any other appropriate entities, individuals, systems, or computers.

Each component of server 282 may communicate using a system bus (not shown). In some implementations, any or all of the components of server 282, hardware or software (or a combination of both hardware and software), may interface with each other or the frontend 238 over the system bus using an application programming interface (API) stored in the code and APIs database 112. The API may include specifications for routines, data structures, and object classes. The API may be either computer-language independent or dependent and refer to a complete interface, a single instruction, or even a set of APIs. Server 282 may have software written in JAVA, C++, Javascript, or other suitable language providing data in extensible markup language (XML) format or other suitable format.

Server 282 may be implemented in a number of different forms and/or virtualized. For example, it may be implemented as a standard server 282, or multiple times in a group of such servers. It may also be implemented as part of a rack server system. In addition, it may be implemented in a personal computer, such as a laptop computer. Server 282 may include components from computing device 200, including the graphical user interface 204, comprising the output subsystem 206 with display 208, speaker 210, and haptic feedback device 212, and further comprising the input subsystem 214 with touch screen 216, buttons and/or keys 218, and microphone 220, as well as the storage device 286, processor 222, and memory 224. All these components implemented in server 282 will perform as described above in the present disclosure. Alternatively, components from server 282 may be combined with other components in a mobile device (not shown), such as computing device 200. Each of such devices may contain one or more of computing device 200 as well as servers 200 and 282, and an entire system may be made up of multiple computing devices 200 as well as servers 280 and 282 communicating with each other. Also, multiple servers 282 may be connected, with each device providing portions of the necessary operations (e.g., as a server bank, a group of blade servers, or a multi-processor system).

The system can include first computing device 200 (e.g., user client device 120 in FIG. 1B), web server 280 (e.g., web server 102 in FIG. 1A), site search server 282 (e.g., site search server 104 in FIG. 1A), and a second computing device 200 (e.g., website owner client device 106 in FIG. 1A). Each of these devices and servers communicate with each other over the network 230. The first computing device 200 may communicate over the network 230 with web server 280 to receive a webpage 100. The link control module 234 in web server 280 may complete steps G and I, as discussed above in FIGS. 1A and 1B. The communication and interaction between the first computing device 200 and the web server 280 is further discussed above in FIG. 1B.

The site search server 282 can communicate over network 230 with web server 280 to generate the improved search engine and search results of webpage 100. In generating the improved search engine and search results of webpage 100, site search server 282 uses the index generator 242. Index generator 242 completes step B as described above in FIG. 1A. Site search server 282 also accesses component 250 with the underlying generators 244, 246, and 248, all of which perform step C as described above in FIG. 1A, to further generate the improved search engine and search results of webpage 100. Finally, site search server 282 uses the index searcher module 252, which completes step 0 as described above in FIG. 1B. Site search server 282 may further communicate with the second computing device 200 over network 230. Once this communication is established, site search server 282 completes steps B-E as discussed above in FIG. 1A. The communication and interaction between web server 280, site search server 282, and the second client device 200 is further discussed above in FIG. 1A.

FIGS. 3A-K are screenshots illustrating an exemplary site search preview interface. The screenshots present an exemplary user experience for presenting, configuring, and deploying a live site search preview for a web site, such as the live preview 118 on the web site owner client device 106, as discussed above in FIG. 1A. The example screenshots can be presented on any of a variety of client computing devices, such as the client computing device 106 described above with regard to FIG. 1A and/or the client computing device 200 described above with regard to FIG. 2. The exemplary screenshots in FIGS. 3A-K may be altered in any of a variety of ways, such as alterations in appearance, style, and/or layout, while still providing the same functionality, processes, and/or methods described in this present disclosure.

FIG. 3A illustrates an exemplary welcome screen displayed to a user at the client device 106. Graphical user interface (e.g., GUI, UI, or user interface) 300 is an interface provided by the site search preview application hosted locally on and served by the site search server 104. The UI 300 displays an index progress status indicator 302 that is a graphical element that shows the progress of index 115 being constructed for the website to the user. Although not shown, before the user at the client device 106 is displayed the UI 300, the user inputs a URL for a webpage 100 into the UI 300. When the site search server 104 receives the URL to the webpage 100, it begins scraping one or more pages of a website that the webpage 100 is associated with to generate the improved search engine and search results. While scraping the website, site search server 104 performs steps B-E, as discussed above in FIG. 1A, and presents to the user at device 106 the exemplary screenshots as discussed below in FIGS. 3B-K.

In FIG. 3A, element 302 displays, to the user, live updates of the status of scraping the entire website. Element 302 may display to the user information comprising a crawler status, how many pages were indexed and/or scraped, and what step in a process of generating the improved search engine the user is up to. The number of pages indexed and/or scraped automatically updates as the user goes through each of the steps in the process. The purpose of element 302 is to demonstrate to the user that indexing and/or scraping the entire website occurs simultaneously as the user views a search preview, tests the search results, and further customizes the search engine. One advantage of simultaneous scraping (e.g., crawling) with user interaction is that the user does not idly wait for scraping to complete before moving on to the next steps in the process, as described below in FIGS. 3B-K. While the steps in the process, as described below in FIGS. 3B-K, are being completed by the user, scraping the website further includes scraping style sheets of the web site and creating a default style for the search results based on the style sheets.

In the depicted example, the element 302 display shows that 128 pages were indexed for the particular website, the crawler status (e.g., indexing and scraping of the entire website and each of the pages therein) is “Running,” and the user is at the first step, “Welcome.” In this example, the user can proceed to the steps “Search Preview,” “Test Search,” and “Explore My Cludo.” In the “Search Preview” step, the user may view what the search results will look like on the webpage. In the “Test Search” step, the user may input test search queries to view how the search results will appear and whether the scraping (e.g., crawling) accurately returned the best results. In the “Explore My Cludo” step, the user may further customize features of the search engine, including but not limited to page rankings, boosting, domains to crawl, and style, font, color, and size of search results. In other embodiments, the steps may appear differently or have different names, styles, fonts, or size. In other embodiments, the steps may not appear in display 302. In other embodiments, the steps may include different functionality for the user. Further, in other embodiments, site search server 104 may display different elements for element 302.

FIG. 3B illustrates an exemplary first screen displayed to demonstrate to a user of a client device how to configure and customize the site search preview. Within the UI 300, the progress of the index 115, that was generated in step B in FIG. 1A, is displayed to the user along with a display 304 of the website for which the site search preview is being generated. The display 304 is a live preview of the webpage 100. Note that site search server 104 is not modifying HTML of the actual webpage 100 accessed from web server 102. Instead, the modifications made, by the user at client device 106, to the website display 304 are done directly on an image of the webpage 100 that is stored locally by the site search server 104. Element 306 identifies the webpage 100 by its URL. The URL is the direct link to the webpage 100 as hosted by the web server 102 for which the site search preview is being generated.

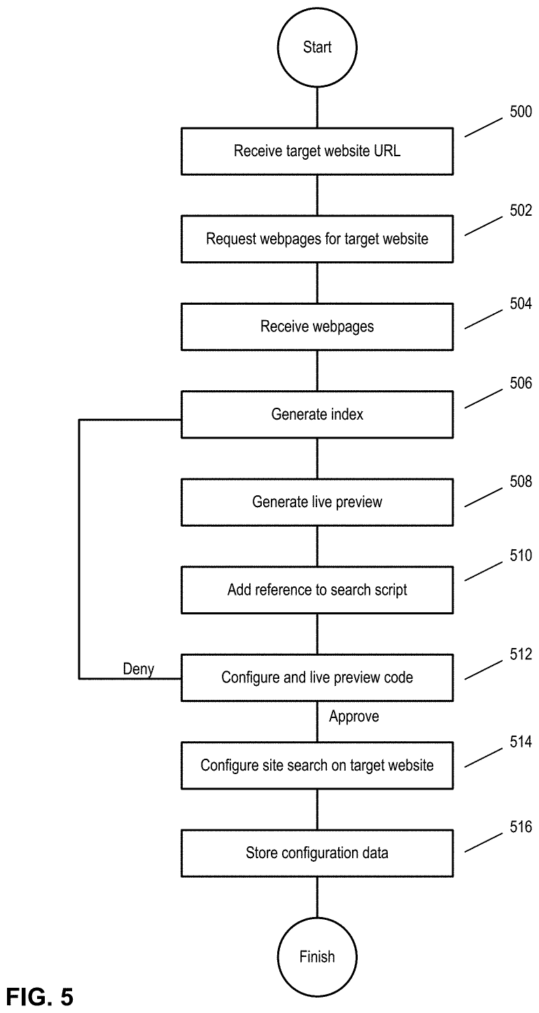

Through the interface 300, the user at client device 106 may add, change, and/or modify the URL in element 306. For example, a user may use the site search preview tool to perform a site search preview across multiple different URLs (e.g., generate single site search engine across multiple different URLs). As a result of such a modification, the server system 104 can update the index that is being generated and the display 304 will present an updated status information for the index 115, generated in step B as discussed above in FIG. 1A, that reflects webpage 100 associated with the modified URL. Additionally, element 302 is updated to demonstrate that the scraping (e.g., crawling) is still “Running,” that at this point in the process 532 pages have been indexed (increased from number indexed in FIG. 5A), and the user completed the “Welcome” step and is currently on the “Search Preview” step. The user has an additional option to “Skip Search Preview” and go to the next step, “Test Search.”

Element 308 displays an option for the user to determine how to display the search results. In this example, the user is prompted with “How should we display the search results?” and the user is provided with two options to choose from: “In the page” or “In a modal window.” Once the user makes a selection of one of those options, the user is prompted to press the “Next” button and move to the next step in the process. Although two options are presented in this illustrative example, the user may be presented with more options about where to place the search results. Additionally, the placement of 304, 306, 302, and 308 may be different, and/or the elements 304, 306, 302, and 308 may appear differently or have different names, styles, fonts, size, or content.

FIG. 3C illustrates an exemplary second screen displayed to the user at the client device 106. In this example, this screen may appear after the user selects to show the search results in the page or in the modal window. In another example, this screen may appear if the user presses the “Skip Search Preview” option in element 302. In FIG. 3C, the user is prompted to identify input field on the website display 304 that will be used to receive input from a user to search the webpage 100 and the entire website the webpage 100 is associated with. Element 310 displays an option for the user to determine which search bar to use in display 304. In this example, the user is prompted with “Which search bar should we use?” The user is asked to select (e.g., click on) an input field in the website display 304 which will be the search bar for the search engine. The user can select a search box 312 or any text input field that appears in display 304.

Before the user selects the input field, the site search server 104 can automatically identify one or more candidate input fields and corresponding identifiers in each webpage 100, and can by default highlight those in the web site display 304. The user can proceed with the default input field identified automatically by the server 104, and/or the user can manually select the input field 312. In response to a user selection, the site search server 104 receives information identifying the input element selected on the client device 106 for and proceeds to store that identifier as the search field to use to provide the site search functionality in the preview.

If the user clicks the option “I don't have an existing search bar” in element 310, then the site search application running locally on the client device generates an input field if no input field is identified in the page, and allows the input field to be moved, by the user at the client device 106, to a desired location on the website display 304. Configuration information identifying the position and other configurations for the search input field can be relayed from the client device 106 to the site search server 104 for use in assembling the code to deploy the site search for the web site.

As a result of the user selecting input field 312, element 314 will populate with the input identifier for the input field 312. Additionally, 302 is updated to demonstrate that the scraping (e.g., crawling) is still “Running,” that in this instance 878 pages have been indexed, and the user completed the “Welcome” step and is currently on the “Search Preview” step. The user has an additional option to “Skip Search Preview” and go to the next step, “Test Search.”

In this example, only one input field can be selected at a time by the user. Further, in another embodiment, the user may select an input field that is not a search bar. For example, the user at the client device 106 may want an ordinary textbox to display names and other search results as a user at the client device 120 begins typing names into the textbox. In some embodiments, autocomplete may display some search results as the user at the client device 120 types into the input field. In other embodiments, the placement of 312, 314, 310, 304, 306, and 302 may be different. Further, in other embodiments, elements 312, 314, 310, 304, 306, and 302 may appear differently or have different names, styles, fonts, size, and/or content.

FIG. 3D illustrates an exemplary, updated second screen displayed to the user at the client device 106. All features described above in FIG. 3C appear and perform the same way in FIG. 3D. As a result of the user selecting input field 312, element 314 is populated with the input identifier that was matched with the input field 312, as described above in FIG. 3C. Additionally, 302 is updated to demonstrate that the scraping (e.g., crawling) is still “Running,” that 1,465 pages were indexed, and the user completed the “Welcome” step and is currently on the “Search Preview” step. The user has an additional option to “Skip Search Preview” and go to the next step, “Test Search.”

FIG. 3E illustrates an exemplary third screen displayed to the user at the client device 106. In this screen, the user is asked to select a container in the website display 304 where search results will be displayed. Element 316 displays an option for the user to determine where the search results should be displayed. In this example, the user is prompted with “Where should we display search results?” The user is asked to click on a container in display 304 where search results will be injected.

Before the user selects the container, the site search server 104 identifies one or more container identifiers corresponding to one or more containers in each webpage 100 and matches the one or more container identifiers to one or more corresponding containers in the website display 304. The site search server 104 then stores the one or more matching container identifiers locally. When the user selects container 318, the site search server 104 receives the user selection at the client device 106 of one of the containers in the website display 304 and matches the one container 318 to the corresponding container identifier stored locally. For instance, the element identifiers for the web site display 304 providing the site search preview may be modified from the identifiers for the corresponding code as hosted by the webserver 102. As a result, the selection of elements (e.g., search input, search results container) in the site search preview interface may be correlated with those from the webserver 102 when constructing code to correctly deploy the site search on the webserver 102.

If the user clicks the option “I can't find a search results container” in element 316, then site search server 104 generates a floating container (not shown) to display search results, wherein the floating container can be moved if no container is identified in the page and by the user at the client device 106, to a desired location on the website display 304. Additionally, element 302 is updated to demonstrate that the scraping (e.g., crawling) is still “Running,” that 1,910 pages have been indexed at this point, and the user completed the “Welcome” step and is currently on the “Search Preview” step. The user has an additional option to “Skip Search Preview” and go to the next step, “Test Search.”

In some embodiments, the site search server 104 may identify search input fields and search result containers in the webpage 100 by looking at a DOM tree of the webpage 100 and listening for selections and/or other user inputs with regard to the DOM elements. In some examples, the user may select a small container or a container within a main container where search results should appear. As a result, the user selection can be automatically modified so that the results properly appear within the larger, main container. The site search preview application running on the client device 106 and/or the site search server 104 can, for example, can move up the webpage element hierarchy to identifier a larger, main container that has sufficient dimensions when rendered, rather than using element that is smaller in size and potentially insufficient to properly display the search results. Such automatic adjustment of the user selection may or may not be presented to the user at the client device 106. For instance, the user may be presented with an outline of the automatically modified container selection area and can be asked to confirm that this is correct.

In this example of FIG. 3E, only one container is selected at a time by the user, but in other instances multiple different containers may be selected. In other embodiments, the placement of 312, 318, 316, 304, 306, and 302 may be different. Further, in other embodiments, elements 312, 318, 316, 304, 306, and 302 may appear differently or have different names, styles, fonts, size, and/or content.

FIG. 3F illustrates an exemplary, updated third screen displayed to the user at the client device 106. All features described above in FIG. 3E appear and perform the same way in FIG. 3F. As a result of the user selecting container 318, element 320 is populated with the container identifier that was matched with the container 318, as described above in FIG. 3E. Additionally, 302 is updated to demonstrate that the scraping (e.g., crawling) is still “Running,” that 2,479 pages have been indexed so far, and the user completed the “Welcome” step and is currently on the “Search Preview” step. The user has an additional option to “Skip Search Preview” and go to the next step, “Test Search.”

FIG. 3G illustrates an exemplary fourth screen displayed to the user at the client device 106. In this screen, the user may view the search results as a search query is typed into input field 312. The user may also customize the search results. The search results appear in element 324. At first, the search results appear in the default style created from site search server 104 scraping the style sheets of the entire web site. Element 324 corresponds to container 318 that the user selected in FIG. 3E. The search results are injected into element 324. In other words, the search results replace content in container 318. Replacing content in container 318 does not involve moving or dynamically replacing other elements or containers in the webpage 100.

Element 322 displays an option for the user to modify a style of the search results. In this example, the user is prompted with “How should we style search results?” The user is asked to adjust various characteristics of the search results in element 322. In this example, the user can modify “Font,” “Size,” and “Color” for “Titles” and “Descriptions.” Further, the user is prompted with: “Hint: try a search in your search bar above to preview results.” The user may type a search query directly into input field 312 and search results will appear and populate element 324. The search results will simultaneously change in the live preview of the website display 304 in the wrapper depending on the modifications the user makes in element 322. The site search server 104, therefore, permits the user at the client device 106 to change a display of the search results in the one container and update, based on the user changes at the client device 106, the display of the search results in the website display 304 in the wrapper appearing. The site search server 104 further receives, from the client device 106, user modifications of the style, font, and size of the search results, and updates the HTML of the webpage 100 with the user modifications.

In one embodiment, site search server 104 replaces content in container 318 within element 324 with the search results, based on the corresponding content identifier as described above in FIG. 3E. Additionally, replacing content in container 318 within element 324 does not involve moving or dynamically replacing other elements or containers on the webpage 100 or other webpages 100 comprising the entire website.

Additionally, element 302 is updated to demonstrate that the scraping (e.g., crawling) is still “Running,” that 3,552 pages have been indexed at this point, and the user completed the “Welcome” step and is currently on the “Search Preview” step. The user has an additional option to “Skip Search Preview” and go to the next step, “Test Search.” In other embodiments, the placement of 304, 302, 312, 324, and 322 may be different. Further, in other embodiments, elements 304, 302, 312, 324, and 322 may appear differently or have different names, styles, fonts, size, and/or content.

FIG. 3H illustrates an exemplary, updated fourth screen displayed to the user at the client device 106. All features described above in FIG. 3G appear and perform the same way in FIG. 3H. The search results appear in element 324 while the user types keyword 326 (e.g., a search query) into input field 312. In this example, because the site search server 104 is still scraping (e.g., crawling) the website, not all search results may appear in element 324. Furthermore, the search results appearing in element 324 may not be in order of relevance or other important categories of ranking. As the user types keyword 326 into the input field 312, the user may also modify characteristics of the titles and descriptions of the search results in element 322. The search results in element 324 will automatically be updated in the live preview of the website in the wrapper within display 304. Additionally, 302 is updated to demonstrate that the scraping (e.g., crawling) is still “Running,” that 3,903 pages have been indexed, and the user completed the “Welcome” step and is currently on the “Search Preview” step. The user as an additional option to “Skip Search Preview” and go to the next step, “Test Search.”

FIG. 3I illustrates an exemplary fifth screen displayed to the user at the client device 106. At this screen, the user moves to the next step in the process, “Test Search.” The user is prompted to input keyword 326 (e.g., search query) into input field 312. In this example, element 328 prompts the user with: “Enter X more unique searches.” X will dynamically change based on how many keywords 326 the user types into input field 312. In this example, the user is required to input 5 keywords 326 into input field 312. Element 330 will display to the user element 332 and a prompt that says “Please note: the crawler is still running. You may find that some pages are missing. Don't sweat—they will be added as the crawl continues!” Other embodiments may display a different prompt or no prompt at all. Furthermore, other embodiments may require a different minimum and/or maximum amount of search queries that the user should input into input field 312.

Element 332 displays 5 segments in a horizontal bar. Each of those segments will turn opaque, a darker color, and/or shaded every time the user inputs keyword 326 into the input field 312. For example, after a first keyword 326 is inputted into input field 312, the first of the five segments in the bar becomes opaque, darker, and/or shaded. After a second keyword 326 is inputted in input field 312, the second of the five segments in the bar will become opaque, darker, and/or shaded. The same process will continue for every keyword 326 inputted in input field 312 until a fifth keyword 326 is inputted. In other embodiments, the horizontal bar will be modified to reflect the same number of segments as there are required test searches. For example, if the user is prompted to input seven test search queries into the input field 312, then the horizontal bar will also have seven segments that will become opaque, darker, and/or shaded every time the user completes one of the required test search queries.

The site search server 104 permits the user at the client device 106 to input one or more searches into the one input field 312 and generate search results based on the user input in element 324. These search results are generated in the live preview of the web site in the wrapper as appears in display 304. In this step, the search results in element 324 are generated based on the scraping (e.g., crawling) that simultaneously occurs by site search server 104 during the earlier steps in the process.

Additionally, element 302 is updated to demonstrate that the scraping (e.g., crawling) is still “Running,” that 4,338 pages have been indexed, and the user completed the “Welcome” step and the “Search Preview” step and is currently on the “Test Search” step. The user may not select an additional option of “Next: Explore My Cludo” to go to the next step because the option is grayed out. The option will become available to the user once the user completes all test searches. The user will know whether all test searches are completed based on elements 328 and 332, which dynamically update with every keyword 326 inputted into input field 312. In this embodiment, the “Test Search” step is one step the user cannot skip. Further, in other embodiments, the placement of 304, 326, 312, 302, 324, 328, 330, and 332 may be different. Further, in other embodiments, elements 304, 326, 312, 302, 324, 328, 330, and 332 may appear differently or have different names, styles, fonts, size, and/or content.

FIG. 3J illustrates an exemplary, updated fifth screen displayed to the user at the client device 106. All features described above in FIG. 3I appear and perform the same way in FIG. 3J. In this example, the user completed the 5 required test searches. As a result, elements 328 and 332 are updated to demonstrate to the user that all the required test searches are complete. The search results also appear in element 324. Additionally, element 302 is updated to demonstrate that the scraping (e.g., crawling) is “Complete,” that 4,859 pages have been indexed, and the user completed the “Welcome” step, the “Search Preview” step, the “Test Search” step, and can now progress to the final step in the process. The option “Next: Explore My Cludo” is also no longer grayed out and the user can click on this option. In this screen, the site search server notifies the user at the client device 106 that scraping is done. In other embodiments, element 302 may update to demonstrate that the scraping is complete during any of the other steps in the process. The duration to scrape the entire website depends on how many webpages comprise the website and how much data the website has. The more data and webpages, the longer it may take to scrape the entire website.

FIG. 3K illustrates an exemplary, updated fifth screen with a pop-out window 334 displayed to the user at the client device 106. The pop-out window 334 is not part of display 304 nor is it part of the live preview of the website in the wrapper. Rather, the pop-out window 334 appears within site search server 104's UI 300. The window 334 provides an option to implement code 336 into webpage 100. The prompt states “Paste this code snippet into the head of your webpages to add search to your live site.” In other embodiments, the prompt may be different or there may be no prompt at all.

The site search server 104 generated the final code 336 for the improved search engine and the preview of search results. Server 104 stores the code 336 which can be either added to the HTML of the webpage 100 and/or provided to client devices to dynamically modify the webpage 100 to show the search results. The server 104 generates a link for the final code 336 so that the improved search engine generated by the server 104 may be implemented on a user client device 120 when the client device 120 requests webpage 100 from the web server 102.

In this example, the final code is Javascript hosted locally by site search server 104 in the code and APIs database 112. In one embodiment, the final code 336 identifies the input field 312, by the input field identifier 314, and the container 318, by the container identifier 320. The input field 312 may be a search bar. The container 318 may be a container on a search results page within the website. The final code 336 is not intended to be complex and is meant to be easily pasted, either directly or indirectly via the link, into the HTML of the webpage 100 by the user at the client device 106.

In this example, element 338 is an option to share a URL link with other users so that the other users can preview the webpage 100 with the improved search engine. In other embodiments, the placement of 336, 338, and 334 may be different. Further, in other embodiments, elements 336, 338, and 334 may appear differently or have different names, styles, fonts, size, and/or content.

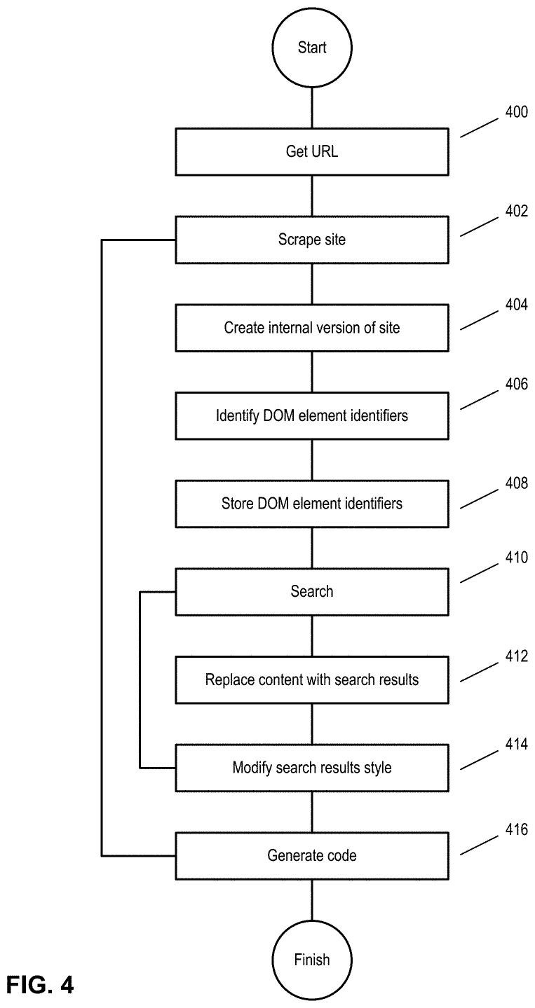

FIG. 4 is a flowchart illustrating an example method for creating a search tool. First, site search server 104 gets a URL to a webpage 100 (400). Then, server 104 scrapes webpage 100 and all of the one or more webpages that comprise a website associated with the webpage 100 (402). While scraping the website, server 104 also scrapes style sheets of the website and generates a simple default style for the search results (402). The scraping continues until all of the pages in the website are examined and used to build the improved search engine. When the scraping is complete, final code is produced for the improved search engine in 414.

While site search server 104 scrapes the website, 404-414 occur. Site search server 104 creates a local version of the webpage 100 that can be modified and/or manipulated to provide the site search preview (and without modifying any aspects of the webpage 100 directly as hosted by the web server 102) (404). The local version can include the same elements as the elements within the webpage 100, but they may be modified so that they are capable of being correctly rendered on the client device 106 (e.g., relative paths may be updated to have complete URL so that resources from the web server 102 can be properly referenced and requested). Then, server 104 provides the renders the local version (e.g., index or image) of the webpage 100 in a wrapper (404). Site search server 104 accesses a DOM tree associated with webpage 100 to identify and store DOM element identifiers for one or more input fields and one or more containers in the webpage 100 (406). In one embodiment, associations between the elements in the local version in the wrapper (e.g., input field(s) and/or container(s)) and the corresponding DOM element identifiers in the corresponding elements in the webpage 100 (e.g., input field(s) and/or container(s)) can be stored for use in generating code to implement the site search on the web server 102.

The site search server 104 can complete all steps described in FIG. 4 directly on the local downloaded version of the webpage 100. Site search server 104 does not modify or change HTML of the webpage 100 and its associated website. All modifications, by site search server 104, are implemented on the local version of webpage 100. Site search server 104 modifies the local version, for example, in the a to present to a user what the webpage 100 and its associated website may look like if the user chooses to implement the improved search engine within the user's website. If the user chooses to implement the improved search engine within the user's website, then the user injects the final code the site search server 104 generates into the HTML of each webpage comprising the user's website, and then the improved search engine with all modifications made by site search server 104 will be reflected in the user's website. If the user, however, chooses not to implement the improved search engine within the user's website, then all of the modifications made by site search server 104 will not be reflected in the user's website and the user's website will function normally as it did before site search server 104 received the URL to the website and began scraping (400 and 402).

In 406, the user may choose any input field within the local version of the webpage 100 to be a search bar. One or multiple input fields can be selected. For example, a website may have a form to input a first and last name of a person. A first input field may resemble the first name and a second input field may resemble the last name. As a second user starts typing into the first input field, suggestions of first names, based on first names scraped within the website, may appear below the first input field. Then, as the second user starts typing into the second input field, suggestions of last names, based on last names associated with the first name and last names scraped within the website, may appear below the second input field.

When the user selects the input field, site search server 104 matches the input field in the local version of the website with the DOM element identifier associated with the matching input field in the actual webpage 100 (406). Once the user selects the input field, the user may begin inputting a search query or keyword into the input field and the site search server 104 may begin a search (408). In one embodiment, site search server 104 begins the search so that the user can test the improved search engine, even if the website is still being scraped. In another embodiment, site search server 104 may not begin the search until scraping the entire website is complete. In yet another embodiment, site search server 104 may not allow the user to input the search query or keyword until later in the steps described in FIG. 4.

Before, during, or after performing steps 406 and/or 408, the user at client device 106 may select a container within the local version to display the search results in. When the user selects the container, server 104 matches the container in the internal version with the DOM element identifier associated with the matching container in the webpage 100. Server 104 then replaces content in the container within the local version with search results (410).

In one embodiment, the selected container may appear in the main part of a search results webpage within a website. In another embodiment, the selected container may be a side panel or other element within any webpage of a website. In other embodiments, the selected container may already have content or search results in it. In this embodiment, site search server 104 will replace that content or search results within the container with the updated search results. Note that site search server 104 will not move other containers in the internal version of webpage 100 to accommodate for the selected container that displays search results. Furthermore, site search server 104 will not alter any other containers of characteristics of the other containers that are within the internal version of webpage 100. Site search server 104 also will not alter or modify in any way containers in other webpages comprising the associated website that may have the same DOM element identifier as the user-selected container in 410.

Note that search step 408 may also occur during and throughout 410 and 412. During 408, the user is prompted to input one or more search queries into the input field while site search server 104 scrapes the entire website (402) and generates search results for display to the user at client device 106. In one embodiment, the search results may not be the most accurate or properly ranked because the site search server 104 is still scraping the entire website. In other embodiments, the may be prompted to input a defined number of search queries into the input field. In yet another embodiment, the user may not be required to input any number of search queries into the input field but may have the option to voluntarily input as many search queries into the input field as the user wants.

The user may also edit an appearance of the search results, including but not limited to a style, font, size, and color of the search results. As a result of these user modifications, site search server 104 will dynamically update the search preview by modifying the search results style based on the user modifications (412). In some embodiments, the user may be required to input one or more search queries into the input field to see how the search results will appear with the user-defined modifications. In other embodiments, the search results already on display in the container may be automatically updated to reflect the user-defined modifications, without site search server 104 requiring the user to input one or more search queries into the input field.

Finally, once site search server 104 completes scraping the entire website (402), server 104 produces (e.g., generates) final code for the improved search engine to be implemented on webpage 100 and the entire website associated with webpage 100 (414). In this particular embodiment, the code is in JavaScript. The code may be hosted locally by site search server 104 in the code and APIs database 112. The code links (e.g., refers) to the improved search engine for implementation on the webpage 100. The code is implemented when client device 120 requests access to the webpage 100 from the web server 102. Refer to FIG. 1B previously discussed above for further description regarding the code implementation.

The description above discussing FIG. 4 generally describes the steps previously described in FIGS. 1-3. However, it will be understood that the method described in FIG. 4 can be performed, for example, by any suitable system, environment, software, and hardware, or a combination of systems, environments, software, and hardware, as appropriate. In some implementations, various steps of the method described in FIG. 4 can be run in parallel, in combination, in loops, or in any order.

FIG. 5 is a flowchart illustrating an example method for generating a search results preview from the perspective of site search server 104. Site search server 104 accesses a webpage 100 through a URL (e.g., link) that refers to the webpage 100 and a website associated with it (500). Next, site search server 104 generates an index (e.g., image or internal version) of webpage 100 and stores the index locally (502). Site search server 104 further renders the index in a wrapper. An example of the index is index 115 in FIG. 1A.

Site search server 104 generates a search preview and UI (e.g., user interface, graphical user interface, or GUI) based on site search server 104's simultaneous scraping of webpage 100 and one or more webpages of the associated website (504). In one embodiment, the search preview and UI resembles the image or internal version (e.g., index 115 in the wrapper) of the webpage 100. The search preview and UI may be interactive, permitting the user at the client device 106 to make modifications to search results that appear in the search preview. For example, some modifications may include, but are not limited to, changing and/or altering a style, font, color, and/or size of search results. Additionally, the user at the client device 106 may input one or more search queries into an input field in the search preview to test the improved search engine.

Once site search server 104 completes scraping the website, the server 104 generates code to view and use the search preview by a user at the client device 106 (506). In this example, the code is in JavaScript, hosted locally by site search server 104 in the code and APIs database 112 (See FIG. 1A). The code links (e.g., refers) to the improved search engine for implementation on the webpage 100. The code is implemented when client device 120 requests access to the webpage 100 from the web server 102. Refer to FIG. 1B previously discussed above for further description regarding the code implementation.

Site search server 104 may modify the local website (e.g., modify HTML of the website, add reference to script to modify HTML) to reflect the improved search engine and search preview (508). Next, site search server 104 provides the search preview to the user at the client device 106 (510). The search preview is live and dynamically updates based on changes and/or modifications the user makes at the client device 106. If the user at the client device 106 approves the search preview, then site search server 104 sends a link referring to the code generated in 506 to web server 102 (512). As a result, when a user at client device 120 requests access to webpage 100 from the web server 102, web server 102 uses the link from 512 to access the improved search engine generated at the site search server 104. Using this link from 512, the improved search engine may be implemented within webpage 100. In another embodiment, if the user at the client device 106 denies the search preview, then site search server 104 returns to 504 to generate a new search preview and UI. This process repeats until the user at the client device 106 approves the search preview.

The description of FIG. 5 generally describes the steps previously described above in FIGS. 1-3. However, it will be understood that the method described in FIG. 5 can be performed, for example, by any suitable system, environment, software, and hardware, or a combination of systems, environments, software, and hardware, as appropriate. In some implementations, various steps of the method described in FIG. 5 can be run in parallel, in combination, in loops, or in any order.

FIGS. 6A-6G are screenshots illustrating exemplary site search preview interfaces in the configuration mode. The screenshots present an exemplary user experience for presenting, configuring, and deploying a live site search preview for a website in the configuration mode, such as the live site search preview 110 on the client computing device 106, as discussed above in FIG. 1A. The example screenshots can be presented on any of a variety of client computing devices, such as the client computing device 106 described above with regard to FIG. 1A and/or the client computing device 200 described above with regard to FIG. 2. The exemplary screenshots in FIGS. 6A-6G may be altered in any of a variety of ways, such as alterations in appearance, style, and/or layout, while still providing the same functionality, processes, and/or methods described in this present disclosure.

FIG. 6A illustrates an exemplary user interface (UI) 600 on the configuration application 120, which is displayed and configured to enable a user to configure site search settings. The UI 600 includes a menu section 602 that has one or more control elements for various functionalities. For example, the menu section 602 includes a control element 604 for search configurations that, once selected, can enable the user to configure search settings 606. In some embodiments, the configuration application 120 operates to present and perform one or more steps to configure the site search functionality in various manners. In FIG. 6A, the search settings 606 allow a user to choose a template for the site search. Examples of templates include an inline style (e.g., iframe) 608 in which search results appear in a dedicated search result page by adding the search results into a main content section of the page, or an overlay style 610 in which search results opens in a window that overlays of top of the page where the search was done. Other template styles are also possible. In the illustrated example, the inline style 608 is selected.

In FIG. 6B, the search settings 606 allow a user to choose a design to display search results. Examples of search result designs include a no-categorization option 612 where search results are displayed with relevant pages for a search query, a categorization option 614 where search results are displayed with relevant pages for a search query and sort them by specified categories, and a categorization-with-image option 616 where search results are displayed with relevant pages for a search query and sort them by specified categories and images. Other designs are also possible. In the illustrated example, the no-categorization option 612 is selected.

In FIG. 6C, the search settings 606 prompts a user to input a URL 614 of a webpage on which search results are displayed. The search results webpage URL 614 can be a URL of one of the existing webpages of the target website. Alternatively, the search results webpage URL 614 can be a URL for a webpage that will be created in the future. In embodiments where the overlay style 610 is selected, the search results webpage URL 614 may not be required.

In FIG. 6D, the UI 600 displays a live preview editor 620 as part of the configuration application 120. The live preview editor 620 shows a live site search preview 110 that displays the webpage accessed through the search results webpage URL 614, and further includes a configuration panel 140. The configuration panel 140 includes one or more control elements that are manually or automatically selected to go through different steps to customize the site search on the webpage. The configuration panel 140 includes a control element 616 for choosing a search results container 618 in which search results will be placed. In some embodiments, the search results container 618 is selected from one of the existing containers on the webpage. In other embodiments, the search results container 618 can be created to be included in the webpage.

In the illustrated example, the user can hold a shift key and hover a cursor over an element where the user wants search results to be displayed. The user can further pass through adjacent elements using, for example, a scroll wheel of a mouse, until a desired element is targeted. In some embodiments, when the shift key is released, the target element (i.e., the search results container 618) can be selected, and a sample of search results can be displayed on the target element. FIG. 6E illustrates that the live preview editor 620 displays example search results 622 in the selected search results container 618. Additionally and/or alternatively, other user input mechanisms are also possible for this and/or other features. For example, instead of pressing the shift key, a user may be able to select a graphical button (e.g., “Choose Element” button) which then enables hovering in the content area instead of the holding shift key. In such instances, users can then select (e.g., click) and/or press a key (e.g., enter key) to lock in the selected element which replaces what would have happened when shift is released.

As illustrated in FIG. 6F, the configuration panel 140 can include a control element 624 for removing one or more unwanted elements from the webpage. In the illustrated example, the user can hold a shift key and hover a cursor over an element where the user wants to remove from the webpage. The user can further pass through adjacent elements using, for example, a scroll wheel of a mouse, until a desired element is targeted. In some embodiments, when the shift key is released, the target element can be removed from the webpage. FIG. 6F illustrates that an element 626 (FIG. 6E) has been removed from the webpage.

In FIG. 6G, the configuration panel 140 includes a control element 628 for initiating customization of styles of the webpage with search results. When the control element 628 is selected, the configuration panel 140 provides control elements to select one of the elements in the webpage, and customize several stylistic attributes of the selected element in the webpage, such as padding, margin, font size, color, etc.

FIG. 6H is a screenshot illustrating an exemplary site search preview interface 650 in the standalone mode. In the standalone mode, the site search preview interface 650 provides the live site search preview 160 without an iframe, so that the site search appears to actually run on the target webpage. As described herein, however, the URL 164 that is shown in the browser 162 in the standalone mode is not a URL hosted by the client web server 102, but a URL hosted by the site search server 104. As described in FIG. 1B, the site search server 104 can access the target webpage from the client web server 102 or retrieve the cached webpage locally at the site search server 104.

FIG. 7 is an example code 670 for the configuration object 134. In some embodiments, the configuration object 134 is formatted as a JSON file. Other data formats are also possible in other embodiments. The configuration object 134 includes information of the user customization that has been performed in the configuration mode of the live site search preview 110. The configuration object 134 can be stored in the site search server 104 and retrieved to render the customized site search on the webpage. In other embodiments, the configuration object can be incorporated in a URL. In some embodiments, the configuration object 134 includes information identifying, for example, a customer ID 672, a search engine ID 674, a template type setting 676, a first search design setting 678, a second search design setting 680, a webpage URL 682, a language setting 684, a CSS file location 686, a search results container 688, a search bar setting 690, a heading setting 692, a custom style setting 694, and an element deletion setting 696. Other information can be included in the configuration object 134.

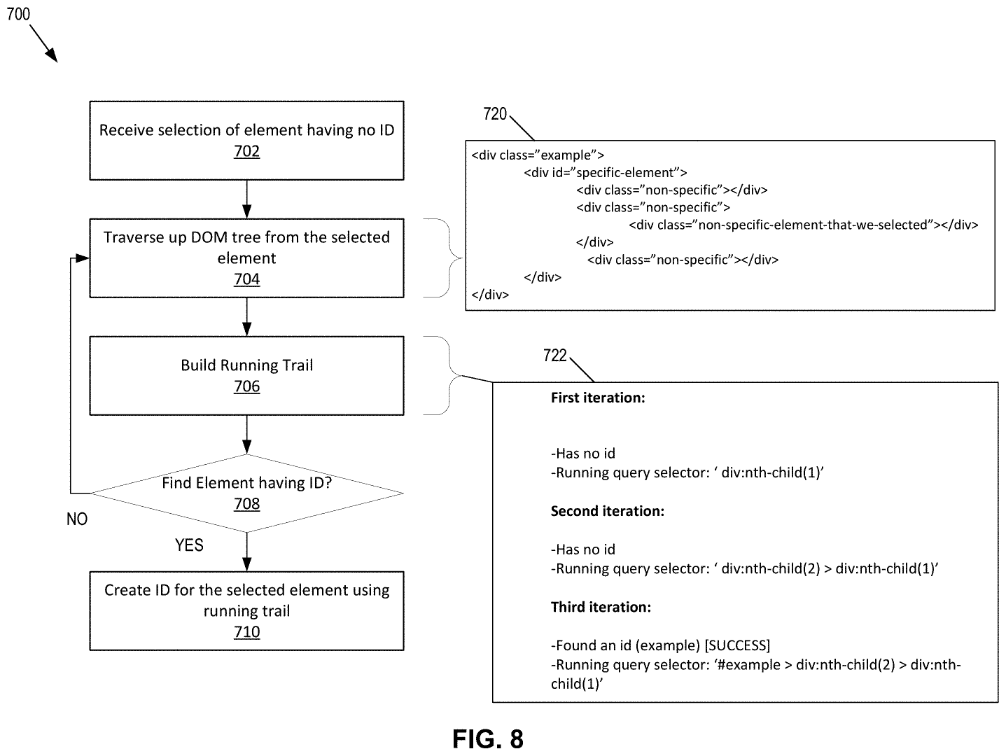

The customer ID 672 includes data identifying the client that wants to include the customized site search on its website. The search engine ID 674 includes data identifying a search engine that is used for the client. The template type setting 676 includes data identifying the template that has been selected by the user in the settings as illustrated for example in FIG. 6A. The first and second search design settings 678 and 680 include data identifying the design settings that have been set up by the user in the settings. Example design settings include whether search results are sorted by specified categories and/or images, as illustrated for example in FIG. 6B. The webpage URL 682 includes data identifying a URL for the client's webpage in which the site search hosted by the site search server 104 is included. The language setting 684 includes data identifying the language preference set up by the user. The CSS file location 686 includes data identifying the location of a default CSS file that is used to render the site search on the webpage. The search results container 688 includes data identifying the element of the webpage in which search results are displayed. The search bar setting 690 includes data identifying whether a search bar is included in the webpage. The heading setting 692 includes data identifying whether a heading is included in the webpage. The custom style setting 694 includes data identifying the stylistic attributes of one or more elements in the webpage which have been customized as illustrated for example in FIG. 6G. The element deletion setting 696 includes data identifying one or more elements which have been removed from the webpage, as illustrated for example in FIG. 6F. In embodiments where an element to be removed from a webpage has an ID, the data of the element deletion setting 696 include the ID of the element. However, in other embodiments, an element to be removed from a webpage has no ID assigned. An example method for identifying such an element without an ID is described with reference to FIG. 8.

FIG. 8 is a flowchart of an example method 700 for determining an element identifier. For example, the method 700 can be used to identify a DOM element to be removed when the DOM element has no identifier. In general, the method 700 identifies a DOM element by passing in a query selector for the element. The method 700 can also be used to identify an element having no identifier in general. The method 700 can be at least partially performed by the site search server 104. In addition or alternatively, other computing devices, such as the client computing device 106 can be involved in performing the method 700.

The method 700 can begin at operation 702 in which the site search server 104 receives a selection of an element to be removed from a webpage. The element has no identifier associated. The selection can be made by a user via the client computing device 106, and transmitted to the site search server 104.

At operation 704, the site search server 104 operates to traverse up a Document Object Model (DOM) from the selected element. For example, the webpage, from which the selected element is to be removed, can be constructed as a DOM which is a tree structure wherein each node is an object representing an element of the webpage. An example DOM is illustrated as code 720. As described below, the site search server 104 operates to begin searching from the selected element and traverse up the DOM in one or more iterations until an element having an identifier is found in the DOM.

At operation 706, the site search server 104 operates to build a running trail 722 while traversing up the DOM. For example, the running trail 722 includes information whether an element having an identifier has been identified in each iteration, and further assigns an identifier to the selected element with respect to the element having the identifier. The running trail 722 can grow until an element having an identifier is found in the DOM.

In some embodiment, if no element having an identifier is identified in a particular iteration, the site search server 104 can assign an identifier to the selected element that may indicate its relationship to the element found in that iteration. By way of example, the element found in the first iteration has no identifier, and thus the selected element is assigned “:nth-child(1)” as an identifier, which indicates the selected element is a first child of the element found in the first iteration. Similarly, when the element found in the second iteration has no identifier, the selected element is assigned with an updated identifier “:nth-child(2)>:nth-child(1)”, which indicates the selected element is a child of the element found in first iteration that is a child of the element found in the second iteration. When the element found in the third iteration is determined to have an identifier “example,” the selected element is assigned with an updated identifier “#example>:nth-child(2)>:nth-child(1)” which indicates the selected element is a child of the element found in the first iteration that is a child of the element found in the second iteration that is a child of the element named “example” found in the third iteration.

At operation 708, the site search server 104 operates to determine whether an element having an identifier is found in the DOM. If an element with an identifier is found (“YES”), the method moves on to operation 710. Otherwise (“NO”), the method returns to operation 704, and repeats the subsequent operations as described above.

At operation 710, the site search server 104 operates to create a final identifier for the selected element using the running trail. In the illustrated example, the identifier created for the selected element is “#example>:nth-child(2)>:nth-child(1).” The identifier assigned to the selected element can be used to identify the removed element in the configuration data.

FIG. 9A is a block diagram illustrating another example system that generates a live preview and site search results while simultaneously scraping a website and permitting a user to edit the search results appearance. One or more webpages 1100 are hosted on a web server 1102. The web server 1102 connects to a web code database 1108 storing code (e.g., HTML, scripts, style sheets, server-side code, client-side code) that the web server 1102 executes and/or distributes to provide the webpages 1100 on client devices. Together, the webpages 1100 can be considered to collectively be a website that is hosted by the web server 1102.

Site search server 1104 is configured to scrape and index one or more webpages 1100 of the website. Site search server 1104 is further configured to generate a search results preview 1118, generate the code to view the search results preview 1118 on a website owner/manager client device 1106, and generate code (e.g., modify HTML) of the one or more webpages 1100 to show the search results. Site search server 1104 can also simultaneously scrape one or more webpages 1100 of the website and, at the same time, generate the improved search engine, preview 1118, and search results for the website.

Site search server 1104 connects to a code and APIs database 1112. The code and APIs database 1112 stores APIs and code (e.g., JavaScript code) hosted by site search server 1104. Site search server 1104 further connects to an index database 1114. The index database 1114 includes indices 1115 for websites that are used by the site search server 1104 to process site search queries for the websites. The site search server 1104 can generate the indices 1115 for the example website and its webpages 1100. In some instances, the database 1114 can additionally store some content from the websites that are indexed, such as HTML code, style sheets, scripts, DOM tree for the interpreted web site, and/or others. The indices 1115 organize the content of the web sites so that they can be readily searched to identify relevant content. The site search server 1104 can provide site search services for the websites that are indexed, such as by receiving search queries from web servers hosting the indexed websites and/or from client devices interpreting the website code, processing the search queries using the indices, and returning the site search results.

A website owner client device 1106 (operated by website owner, manager, or other person/entity who controls what is presented on the website) communicates with the site search server 1104. The website owner client device 1106 can be used to initiate, review, and approve site search previews, as described in greater detail below.

As part of providing a site search preview for the example website, the site search server 1104 communicates with web server 1102 to access the webpages 1100 for the website (Step A). This can be initiated, for example, in response to the site search server 1104 having received a request from the website owner client device 1106 (and/or other client device) to initiate a site search preview for the website and its webpages 1100. Accessing the webpages can include, for example, the site search server 1104 receiving one or more URLs to the website (e.g., URL for root webpage on website), requesting the webpage from the web server 1102, receiving the webpage, and then crawling the website by, for example, recursively crawling the links provided in the webpages 1100 for the website to identify additional pages to request. Once site search server 1104 has begun receiving the webpages 1100 for the website from the web server 1102, the site search server 1104 can begin scraping the content from the webpages 1100 to generate an improved search engine and corresponding index for the website.

The site search server 1104 generates the index 1115 of the website and its webpages 1100, and stores the index 1115 locally in the index database 1114 (Step B). The index 1115 can include, for example, a data structure that organizes the content of the webpages 1100 for the website along one or more dimensions (e.g., associations between webpages 1100 and search query terms). The index 1115 can also include, for example, modifications to the data structure, which may be directed (e.g., website owner identification of particular web page that is most relevant to particular search query) and/or inferred (e.g., correlation between search queries and particular web pages based on previous user behavior when receiving search results for the same or similar search queries),

The site search server 1104 uses the index 1115 to provide a live search preview 1118 on the website owner client device 1106 (Step C). Providing the live search preview 1118 can include, for example, generating code to implement the search preview in a way that presents the search interface and results on a web page that mimics the webpages 1100 of the website without having to be coded or implemented by the web server 1102. For example, the site search server 1104 can receive and modify code (e.g., HTML, JavaScript) of the webpage 1100 that it receives from the web server 1102, and can provide the modified code to the website owner client device 1106 for presenting the site search preview. The site search server 1104 can also provide additional code that provides the site search interface on the client device 1106. For example, the site search server 1104 can have a site search preview application (first code portion) that presents an interface through which the user can customize and view the site search preview. The site search preview application can effectively acts as a wrapper for the modified webpage 1100 (second code portion) generated by the site search server 1104. For instance, the site search preview application can be a web application that includes an iframe in which the modified webpage 1100 is presented. As part of generating the code in step C, the site search server 1104 accesses the code and APIs database 1112, which can store, for example, the site search preview application, the modified webpage 1100, configuration information for the site search on the website and webpages 1100 (e.g., information identifying an input field and a container for the site search on the webpages 1100), APIs to provide site search functionality on the webpages 1100, and/or other details. The input field can be a search bar where a user inputs a search query. The container can be a reserved portion of the webpage 1100 in which the search results associated with the search query are presented.

The site search server 1104 provides a live search preview 1118 with a graphical user interface (e.g., GUI or UI) of search results on the client device 1106 (Step D). The preview 1118 is presented on the client device 1106 through the site search preview application and the modified HTML from step C, which are provided to and executed/interpreted by the client device 1106. The URL 1116 for the site search preview 1118 can be a URL hosted by the site search server 1104, and links for the web search preview 1118 can also link back to the site search server 1104. The site search preview 1118 can involve a number of guided steps that a user of the client device 1104 can follow to place a search input field and search results container on the website, in addition to designating other site search parameters and configurations. These user designations can be used by the site search preview application being executed locally on the client device 1104 as part of the site search preview 1118 to further modify the webpage 1100 to present the site search preview (e.g., dynamically modify DOM to present search input field and modified container at specified locations). These user designations can also be relayed back to the site search server 1104, which can use them to customize the site search engine for the webpages 1100 and to build a script hosted on the site search server 1104 that can implement the site search on webpages 1100 (e.g., implemented by linking to the script with, for example, a simple include statement). Once the input field and the search results container have been designated, the client device 1106 can receive search queries (e.g., test queries) from a user via the site search preview 1118 and can transmit them to the site search server 1104, which can process the search queries using the index generated in Step B and provide site search results to the client device 1106 of presentation to the user in the site search preview 1118 interface.

The site search preview 1118 can permit a user to make changes (e.g., modifications) to the site search configurations at the client device 1106, which can be relayed to the site search server 1104 to provide a configurable live updated preview 1118 on the client device 1106. Note that while the site search server 1104 is scraping the website associated with webpage 1100, site search server 1104 is also scraping style sheets of the website associated with webpage 1100 and creating a default style for the search results, based on those style sheets. In one example, if the user at the website owner client device 1106 does not like the default style of preview 1118, the user can modify at least one or more of a style, font, and size of the search results. Once the user makes these modifications, the site search server 1104 updates the site search preview 1118 with the user modifications, presents to the user a live, updated preview 1118, and stores the site search code and configurations to reflect the modifications (e.g., changes). For example, the code and configurations can be stored in the code and APIs database 1112.

Although the Steps A-D are presented as being sequential, they are performed concurrently and in parallel, in many instances. For example, the preview 1118 can allow a user at the website client owner device 1106 to input a search query into one of the input fields designated as the search bar and watch search results populate a container in the preview 1118 (Step D) while the index is still being generated for the website (Step B). Depending on the website and the amount of content on the webpages 1100, indexing the webpages 1100 (Step B) may take longer than the process for the user of the client device 1106 to configure and setup the site search preview (Step D). The site search server 1104 can process search queries and return search results with a partially completed index while continuing to build the full index. For example, the preview 1118 can populate with search results while the site search server 1104 is still scraping the website associated with the webpage 1100 and building the index. As a result, the search results provided in the preview 1118 while the index is still being constructed may not be as accurate as they would be once the index has been fully constructed (e.g., most relevant results may not be highest ranked in site search results). However, by providing site search results while the site search index is still being generated, the site search preview can be improved and can provide users with a real sense of the look and feel of the site search functionality as it would exist on the web site (with webpages 1100) without having to modify any aspects of the website.

Once the search results have been presented and previewed in the interface 1118, the website owner client device 1106 can be provided with an option in the preview interface 1118 to approve and deploy the site search functionality hosted by the site search server 1104 on the website and its webpages 1100 (Step E). In response to the device 1106 approving the deployment of the site search with the site search server 1104, the site search server 1104 can generate a link to the code and configurations generated to provide the site search (e.g., script specifying the placement of the search input field and search results container on the webpages 1100). The code and configurations can be updated to reflect any changes the user at the website owner client device 1106 made to the preview 1118 and the improved search engine. For example, a user at the client device 1106 may change a display of the search results from one container to another (i.e., a search results container on a search results page of a website).

Once all user modifications (e.g., customizations) are complete and the website owner client device 1106 approves the preview 1118, site search server 1104 generates a link 1110 for the final code and sends (e.g., provides) link 1110 for incorporation on the web code 1108 that is served by the web server 1102 (Step F). For example, the user of the client device 1106 can modify the underlying code 1108 for the website to include the link 1110 to the code to implement the site search functionality that was previewed and finalized via the site search server 1104 (Step G). As a result, web server 1102 can link to site search server 1104's stored code in the code and APIs database 1112 for the webpage 1100. Therefore, when a second client device requests access to a webpage 1100, web server 1102 serves the code 1108 with the link 1110, which is interpreted by the second client device to request the code from the site search server 1104 to provide the improved site search functionality for the website on the second client device. An example of this interaction with a second client device is described below with regard to FIG. 9B.

For example, an owner of examplesite.com created an improved search engine using the servers of site search server 1104. After the owner approved the live preview 1118, site search server 1104 presented the owner with JavaScript code for the improved search engine of examplesite.com, which is hosted locally by site search server 1104. The owner then injected the JavaScript code into the actual HTML of each of the webpages comprising examplesite.com, which can be done directly by incorporating the JavaScript code generated by the site search preview or by linking to the JavaScript code hosted on the site search server 1104. Then, a user, over the internet, accesses examplesite.com and inputs a search query into a search bar located on examplesite.com homepage. As a result of the search query, web server 1102 links, through the code injected in the HTML of examplesite.com, to the improved search engine generated by site search server 1104. Web server 1102 accesses the improved search engine and therefore is able to display, to the user on examplesite.com, search results associated with the search query.

In some embodiments, the user at the client device 106 may have the option to save the generated code. Then, the user can inject, at a later time, the code into the actual HTML of the webpage 100 and every page comprising the website associated with webpage 100. Alternatively, saving the code may be beneficial to modify the code later based on improvements made to the generated search engine.

FIG. 9B is a block diagram illustrating an example system in run-time, when a user device receives the updated search results. In this example, a user client device 1120 communicates with the web server 1102 and requests webpage 1100 to be displayed on user client device 1120 (Step H). In response to the request, the web server 1102 accesses the web code database 1108 and provides the requested code, which has been updated (after completing the site search preview, FIG. 9A) to include link 1110 (Step I). In this step, web server 1120 provides webpage 1100 with the link 1110 to the user client device 1120. Next, user client device 1120 interprets the webpage code from the web server 1102 and, as part of interpreting the link 1110 (e.g., include statement with link 1110), transmits a request to the site search server 1104 requesting the code identified by the link 1110 (Step J). In this example, the site search code 1124 for the website that was generated via the site search preview (FIG. 9A) is identified as site code 1124. In requesting the link 1110 from server 1104, the user client device 1120 requests site code 1124. Code 1124 includes code and configurations to implement the improved site search functionality generated by server 1104 for a particular website associated with webpage 1100. See FIG. 9A previously discussed for generating the improved search engine.

In response to receiving the request, the server 1104 accesses the code and APIs database 1112 to get the site code 1124 (Step K). The server 1104 then provides code 1124 to the client device 1120 so that the client device 1120 may implement the improved search engine for the webpage 1100. In response to receiving the site search code 1124, the device 1120 renders the code 1124 by displaying the improved search engine (Step L). Such rendering can include, for example, dynamic implementation of the site search functionality through identifying relevant elements in the DOM tree for the web code 1108 and placing code for the search input element and/or search results container element in appropriate locations. Using the webpage rendered on the client device 1120 to include the site search functionality, a user at the client device 1120 performs a search query by inputting text into an input field (Step M). The input field may be a search box and/or other appropriate search interface (e.g., voice interface, gesture based interface, geolocation identifier).

After the user inputs the search query, the search query is sent back to the site search server 1104 according to the site code 1124 that has been implemented in and added to the web code 1108 on the client device 1120 (Step N). In response to receiving the search query, the server 1104 accesses the index database 1114 to get a corresponding website index 1122 for the webpage 1100 (Step 0). Note that the index 1122 can be the same index that is generated in Step B during the site search preview, which can provide a variety of advantages. For example, by reusing the index 1122, the server 1104 can avoid duplicating the efforts to scrape the webpages 1100 and to build the index 1122. Additionally, the server 1104 can also permit for the site search functionality to instantaneously go live on the website on the web server 1102 without having to first wait to build the index. Once server 1104 retrieves the corresponding index 1122, the server 1104 searches the index 1122 to identify the search results for the user search query, and the search results are sent back to device 1120 (Step P). The search results are displayed on the user at device 1120, for example, by replacing content within a container designated for displaying search results in the improved search engine. The container designated for displaying search results is identified in the code 1124.

Various implementations of the systems and techniques described here can be realized in a digital electronic circuity, integrated circuitry, specially designs ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. Other programming paradigms can be used, e.g., functional programming, logical programming, or other programming. As used herein, the terms “machine-readable medium” and “computer-readable medium” refer to any computer program, product, apparatus, and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11a/b/g/n or 802.20 (or a combination of 802.11x and 802.20 or other protocols consistent with this disclosure), all or a portion of the Internet, or any other communication system or systems at one or more locations (or a combination of communication networks). The network can communicate with, for example, Internet Protocol (IP) packets, Frame Relay frames, Asynchronous Transfer Mode (ATM) cells, voice, video, data, or other suitable information (or a combination of communication types) between network addresses.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or on the scope of what can be claimed, but rather as descriptions of features that can be specific to particular implementations of particular inventions. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain this disclosure. Other changes, substitutions, and alterations are also possible without departing from the spirit and scope of this disclosure. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method for providing a preview of a site search for a website, comprising:
receiving, using at least one computing device, a user input of a target website URL for a target website to which a site search is incorporated;
transmitting a configuration preview request to a site search server system, the request including the target website URL, wherein the site search server system accesses the target website in response to the configuration preview request and generates first site search preview code;
receiving the first site search preview code from the site search server system;
rendering a preview of the site search in a configuration mode using the first site search preview by displaying the preview of the site search within a frame of a configuration application;
receiving a user input of configuring the site search using the configuration application;
modifying the display of the preview of the site search in the configuration mode based on the user input; and
generating configuration data based on the user input, the configuration data usable to render a modified site search in the target website.

2. The method of claim 1, further comprising:
generating a standalone preview request including a URL hosted by the site search server system, the URL incorporating the configuration data and identifying the target website URL.

3. The method of claim 1, wherein the configuration data is in an encoded JSON format.

4. The method of claim 1, further comprising:
transmitting the configuration data to the site search server system, the configuration data stored in the site search server system.

5. The method of claim 1, further comprising:
receiving, using the at least one computing device, a user request for a preview of the site search in a standalone mode;
transmitting a standalone preview request to the site search server system, the request including the target website URL and the configuration data;
receiving second site search preview code from the site search server system; and
rendering a preview of the modified site search in the standalone mode using the second site preview code and the configuration data by displaying the preview of the modified site search on a browser running on at least one computing device.

6. The method of claim 5, wherein, in the standalone mode, the preview of the site search is displayed without the frame of the configuration application.

7. The method of claim 4, further comprising:
receiving, using the at least one computing device, a user request for a preview of the site search in a standalone mode;
transmitting a standalone preview request to the site search server system, the request including the target web site URL;
receiving second site search preview code and the configuration object from the site search server system; and
rendering a preview of the modified site search in the standalone mode using the second site preview code and the configuration data by displaying the preview of the modified site search on a browser running on the at least one computing device.

8. The method of claim 1, wherein the user input of configuring the site search includes at least one of selecting a search result template, selecting a search result sorting type, selecting a language preference, adding a search bar, adding a heading, customizing a style, selecting a search result container, and removing one or more elements from the website.

9. A site search server system comprising:
a data processing apparatus; and
a memory device storing instructions that when executed by the data processing apparatus cause the site search server system to perform operations comprising:
receiving a configuration preview request from the client computing device, the configuration preview request including a target website URL for a target website to which a site search is incorporated;
accessing the target website in response to the configuration preview request;
generating first site search preview code;
transmitting the first site search preview code to the client computing device, the first site search preview code being used by the client computing device to render a configuration preview mode for a site search in the target website by displaying a preview of the site search within a frame of a configuration application; and
receiving configuration data from the client computing device, the configuration data including configuration of the site search made using the configuration application.

10. The site search server system of claim 9, wherein the instructions further cause the site search server system to perform operations comprising:
scraping the target website from the client web server; and
indexing the target website.

11. The site search server system of claim 9, wherein the instructions further cause the site search server system to perform operations comprising:
adding reference to a site search script to the target web site, the site search script identifying a site search engine for the target web site, the site search engine hosted by the site search server system.

12. The site search server system of claim 9, further comprising a configuration database, wherein the instructions further cause the site search server system to perform operations comprising:
storing the configuration data in the configuration database.

13. The site search server system of claim 9, wherein the instructions further cause the site search server system to perform operations comprising:
receiving a standalone preview request from the client computing device, the standalone preview request including the target website URL and the configuration data;
transmitting second site search preview code to the client computing device, the second site search preview code being used by the client computing device to generate a standalone preview mode for the site search in the target website by displaying a preview of the site search on a browser running on the client computing device, the preview of the site search modified based on the configuration data.

14. The site search server system of claim 9, wherein the instructions further cause the site search server system to perform operations comprising:
receiving a standalone preview request from the client computing device, the standalone preview request including the target website URL;
transmitting second site search preview code and the configuration data to the client computing device, the second site search preview code being used by the client computing device to generate a standalone preview mode for the site search in the target website by displaying a preview of the site search on a browser running on the client computing device, the preview of the site search modified based on the configuration data.

15. The site search server system of claim 13, wherein, in the standalone mode, the preview of the site search is displayed without the frame of the configuration application.

16. The site search server system of claim 9, wherein the configuration data include information about at least one of a search result template, a search result sorting type, a language preference, a search bar, a heading, customizing a style, a search result container, and one or more elements removed from the website.

17. The site search server system of claim 9, wherein the instructions further cause the site search server system to perform operations comprising:
receiving a request for removing a subject element from the target website, the subject element having no identifier;
obtaining a Document Object Model (DOM) for the target website;
traversing up the DOM from the subject element;
identifying a reference element having an identifier in the DOM building a running trail from the subject element and the reference element; and
creating an identifier for the subject element using the running trail.

18. A non-transitory computer-readable medium having stored therein a program for causing a computer to execute a process of providing a preview of a site search for a website, the process comprising:
receiving a user input of a target web site URL for a target web site to which a site search is incorporated;
transmitting a configuration preview request to a site search server system, the request including the target web site URL, wherein the site search server system accesses the target web site in response to the configuration preview request and generates first site search preview code;
receiving the first site search preview code from the site search server system;
rendering a preview of the site search in a configuration mode using the first site search preview by displaying the preview of the site search within a frame of a configuration application;
receiving a user input of configuring the site search using the configuration application;
modifying the display of the preview of the site search in the configuration mode based on the user input; and
generating configuration data based on the user input, the configuration data usable to render a modified site search in the target website.

19. The non-transitory computer-readable medium of claim 18, the process further comprising:
receiving a user request for a preview of the site search in a standalone mode;
transmitting a standalone preview request to the site search server system, the request including the target website URL and the configuration data;
receiving second site search preview code from the site search server system; and
rendering a preview of the modified site search in the standalone mode using the second site preview code and the configuration data by displaying the preview of the modified site search on a browser running on the at least one computing device.

20. The non-transitory computer-readable medium of claim 18, wherein the user input of configuring the site search includes at least one of selecting a search result template, selecting a search result sorting type, selecting a language preference, adding a search bar, adding a heading, customizing a style, selecting a search result container, and removing one or more elements from the web site.
